(19) United States
(12) Patent Application Publication
(10) Pub. No.: US 2025/0259654 A1
(43) Pub. Date: Aug. 14, 2025

(54) SYSTEM AND METHOD FOR PRODUCING A VIDEO STREAM

(71) Applicant: LIVEARENA TECHNOLOGIES AB, TÄBY (SE)

(72) Inventors: Andreas BJÖRKMAN, TÄBY (SE); Anders NILSSON, Falköping (SE); Lars ERLMAN, LEKSAND (SE); Maxx SÖRQVIST, BÅLSTA (SE)

(21) Appl. No.: 19/190,836

(22) Filed: Apr. 28, 2025

Related U.S. Application Data
(63) Continuation of application No. 18/929,694, filed on Oct. 29, 2024.
Application No. 18/929,694 is a continuation of application No. PCT/SE2023/050767, filed on Aug. 1, 2023.

(30) Foreign Application Priority Data
Aug. 2, 2022 (SE) 2250945-9

(51) Int. Cl. G11B 27/031; G06V 10/70; H04N 7/15

(52) U.S. Cl. CPC G11B 27/031; G06V 10/70; H04N 7/15

(57) ABSTRACT

Method, system and computer program product for providing an output digital video stream enhanced by real-time analysis. A primary digital video stream is continuously captured and analyzed locally to detect initial events or patterns, generating a first control parameter with a first delay. A more complex image or audio analysis is performed remotely, identifying additional events and generating a second control parameter with a longer delay. The second parameter is applied to a later point in the stream, allowing seamless, real-time modification without playback interruption. The modified video stream is delivered to clients as a final output. The first primary digital video stream is continuously captured by a camera local to the participating client and a computer device performing the analysis and application of the first production control parameter. The second analysis is performed by a computer device remote to the computer device applying the first production control parameter.

The present invention relates to a system, computer software product and method for producing a digital video stream, and in particular for producing a digital video stream based on digital input video streams. In preferred embodiments, the digital video stream is produced in the context of a digital video conference or a digital video conference or meeting system, particularly involving a plurality of different concurrent users. The produced digital video stream may be published externally or within a digital video conference or digital video conference system.

In other embodiments, the present invention is applied in contexts that are not digital video conferences, but where several digital video input streams are handled concurrently and combined into a produced digital video stream. For instance, such contexts may be educational or instructional.

There are many known digital video conference systems, such as Microsoft® Teams®, Zoom® and Google® Meet®, offering two or more participants to meet virtually using digital video and audio recorded locally and broadcast to all participants to emulate a physical meeting.

There is a general need to improve such digital video conference solutions, in particular with respect to the production of viewed content, such as what is shown to whom at what time, and via what distribution channels.

For instance, some systems automatically detect a currently talking participant, and show the corresponding video feed of the talking participant to the other participants. In many systems it is possible to share graphics, such as the currently displayed screen, a viewing window or a digital presentation. As virtual meetings become more complex, however, it quickly becomes more difficult for the service to know what of all currently available information to show to each participant at each point in time.

In other examples a presenting participant moves around while talking about slides in a digital presentation. The system then needs to decide whether to show the presentation, the presenter or both, or to switch between the two.

It may be desirable to produce one or several output digital video streams based on a number of input digital video streams by an automatic production process, and to provide such produced digital video stream or streams to one or several consuming entities.

However, in many cases it is difficult for a dynamic conference screen layout manager or other automated production function to select what information to show, due to a number of technical difficulties facing such digital video conference systems.

Firstly, since a digital video meeting has a real-time aspect, it is important that latency is low. This poses problems when different incoming digital video streams, such as from different participants joining using different hardware, are associated with different latencies, frame rates, aspect ratios or resolutions. Many times, such incoming digital video streams need processing for a well-formed user experience.

Secondly, production in the sense of video image processing, selection and formatting introduces latency that may be undesired in a real-time video communication between participants.

Thirdly, there is a problem with time synchronisation. Like too high latency, unsynchronised digital video feeds will lead to poor user experiences.

These problems are amplified in more complex meeting situations, for instance involving many participants; participants using different hardware and/or software to connect; externally provided digital video streams; screen-sharing; or multiple hosts.

These problems are specifically present in a context where a number of participants participate in a video conference or similar, where either all participants are locally present in the same room or premise or where some participants are locally present and some participants participate remotely.

The corresponding problems arise in said other contexts where an output digital video stream is to be produced based on several input digital video streams, such as in digital video production systems for education and instruction.

Swedish application SE 2151267-8, which has not been published at the effective date of the present application, discloses various solutions to the above-discussed problems.

Swedish application 2151461-7, which also not been published at the effective date of the present application, discloses various solutions specific to the handling of latency in multi-participant digital video environments, such as when different groups of participants are associated with different general latency.

Swedish application 2250113-4, which also not been published at the effective date of the present application, discloses various solutions specific to the use of one or several cameras to track one or several persons.

The present invention solves one or several of the above described problems.

Hence, the invention relates to a method for providing an output digital video stream, the method comprising continuously collecting a real-time first primary digital video stream; performing a first digital image analysis of the first primary digital video stream so as to identify at least one first event or pattern in the first primary digital video stream, the first digital image analysis resulting in a first production control parameter being established based on the detection of said first event or pattern, the first digital image analysis taking a certain time to perform causing the first production control parameter to be established after a first time delay in relation to a time of occurrence of said first event or pattern in the first primary digital video stream; applying said first production control parameter to said real-time first primary digital video stream, the application of the first production control parameter resulting in the first primary digital video stream being modified based on said first production control parameter without being delayed by said first time delay, so as to produce a first produced digital video stream; and continuously providing said output digital video stream to at least one participating client, the output digital video stream being provided in the form of, or based on, said first produced digital video stream.

Furthermore, the invention relates to a computer program product comprising instructions which, when the program is executed by a computer, cause the computer to carry out said method for providing an output digital video stream.

Moreover, the invention relates to a system for providing an output digital video stream, the system comprising a collecting function, arranged to continuously collect a real-time first primary digital video stream; a production function, arranged to perform a first digital image analysis of the first primary digital video stream so as to identify at least one first event or pattern in the first primary digital video stream, the first digital image analysis resulting in a first production control parameter being established based on the detection of said first event or pattern, the first digital image analysis taking a certain time to perform causing the first production control parameter to be established after a first time delay in relation to a time of occurrence of said first event or pattern in the first primary digital video stream, the production function further being arranged to apply said first production control parameter to said real-time first primary digital video stream, the application of the first production control parameter resulting in the first primary digital video stream being modified based on said first production control parameter without being delayed by said first time delay, so as to produce a first produced digital video stream; and a publication function, arranged to continuously provide said output digital video stream to at least one participating client, the output digital video stream being provided in the form of, or based on, said first produced digital video stream.

In the following, the invention will be described in detail, with reference to exemplifying embodiments of the invention and to the enclosed drawings, wherein:

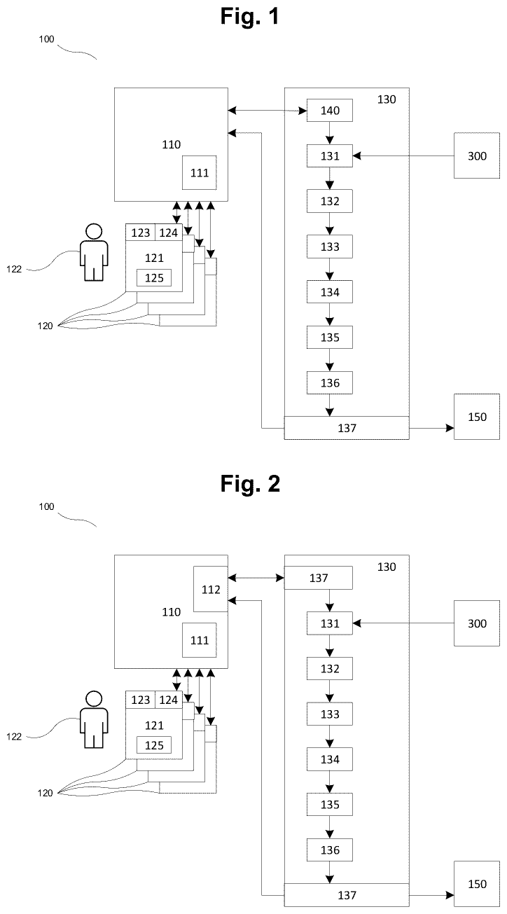

FIG. 1 illustrates a first exemplifying system;

FIG. 2 illustrates a second exemplifying system;

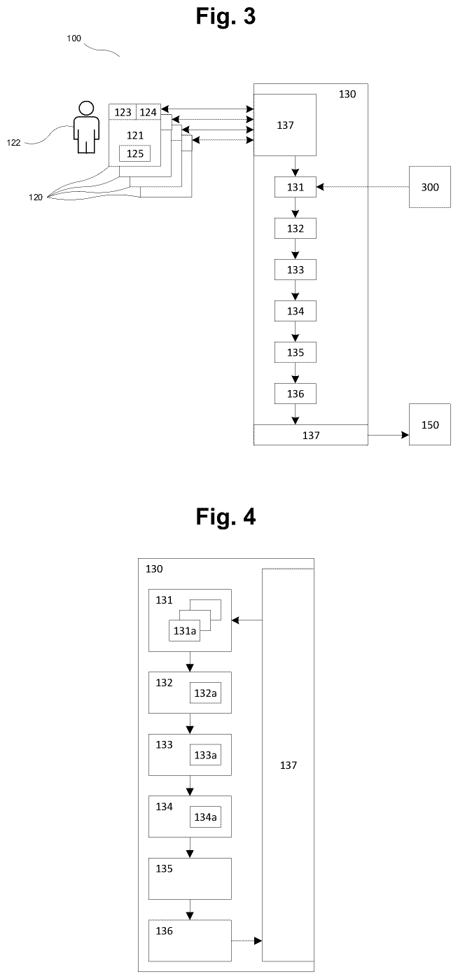

FIG. 3 illustrates a third exemplifying system;

FIG. 4 illustrates a central server;

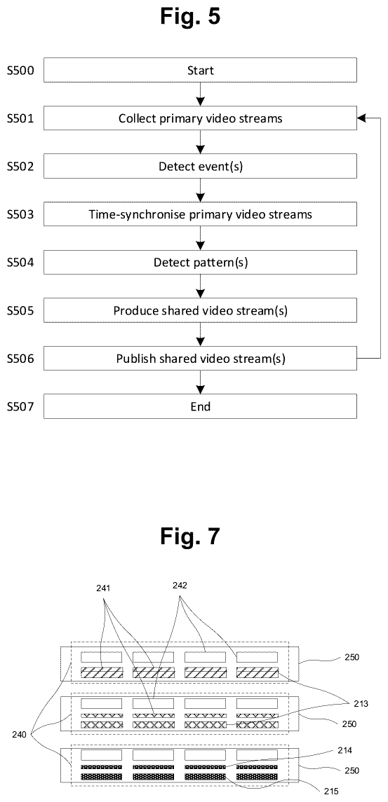

FIG. 5 illustrates a first method;

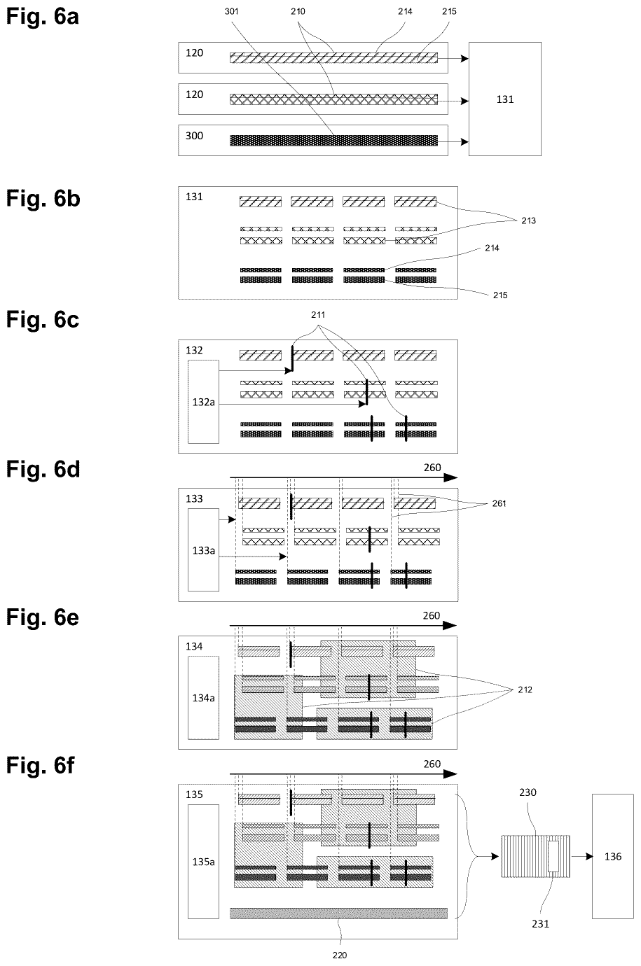

FIGS. 6a-6f illustrate subsequent states in relation to the different method steps in the method illustrated in FIG. 5;

FIG. 7 illustrates, conceptually, a common protocol;

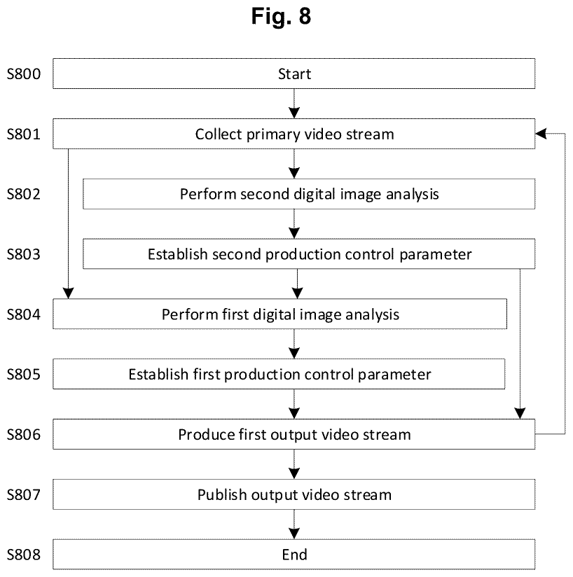

FIG. 8 illustrates a second method;

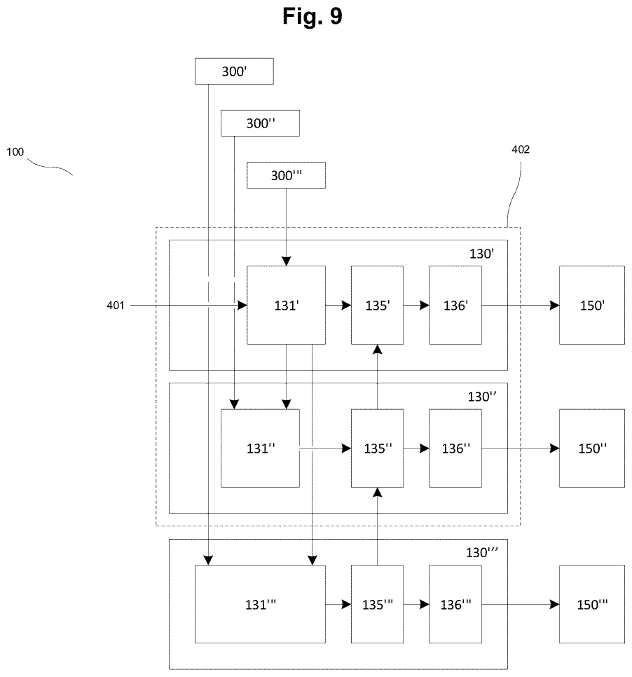

FIG. 9 illustrates a fourth exemplifying system; and

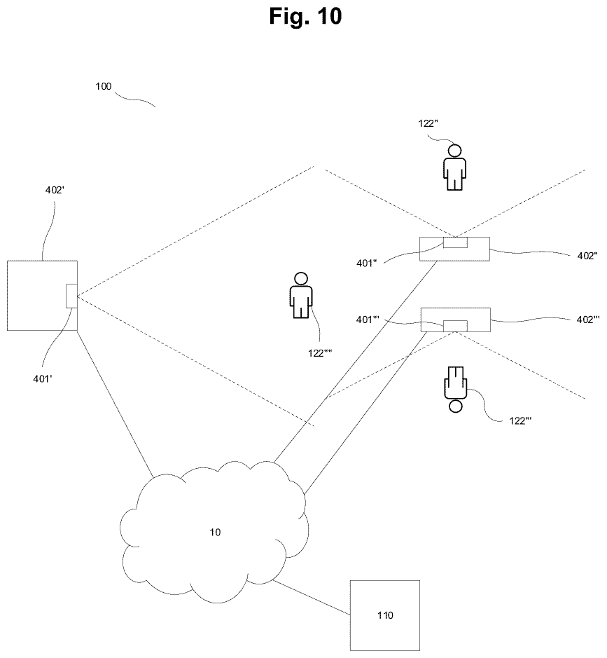

FIG. 10 illustrates a fifth exemplifying system.

All Figures share reference numerals for the same or corresponding parts.

FIG. 1 illustrates a system 100 according to the present invention, arranged to perform a method according to the invention for providing an output digital video stream, such as a shared digital video stream.

The system 100 may comprise a video communication service 110, but the video communication service 110 may also be external to the system 100 in some embodiments. As will be discussed, there may be more than one video communication service 110.

The system 100 may comprise one or several participant clients 121, but one, some or all participant clients 121 may also be external to the system 100 in some embodiments.

The system 100 may comprise a central server 130.

As used herein, the term “central server” is a computer-implemented functionality that is arranged to be accessed in a logically centralised manner, such as via a well-defined API (Application Programming Interface). The functionality of such a central server may be implemented purely in computer software, or in a combination of software with virtual and/or physical hardware. It may be implemented on a standalone physical or virtual server computer or be distributed across several interconnected physical and/or virtual server computers.

As will be exemplified below, in some embodiments the central server comprises or is in its entirety a piece of hardware that is locally arranged in relation to one or several of said participating clients 121. As used herein, that two entities are “locally arranged” in relation to each other means that they are arranged within the same premises, such as in the same building, for instance in the same room, and preferably interconnected for local communication using a dedicated cable or local area network connection, as opposed to via the open internet.

The physical or virtual hardware that the central server 130 runs on, in other words that computer software defining the functionality of the central server 130 executes on, may comprise a per se conventional CPU, a per se conventional GPU, a per se conventional RAM/ROM memory, a per se conventional computer bus, and a per se conventional external communication functionality such as an internet connection.

Each video communication service 110, to the extent it is used, is also a central server in said sense, that may be a different central server than the central server 130 or a part of the central server 130. In particular, the or each video communication service 110 may be locally arranged in relation to one, several or all of the participating clients 121.

Correspondingly, each of said participant clients 121 may be a central server in said sense, with the corresponding interpretation, and physical or virtual hardware that each participant client 121 runs on, in other words that computer software defining the functionality of the participant client 121 executes on, may also comprise a per se conventional CPU/GPU, a per se conventional RAM/ROM memory, a per se conventional computer bus, and a per se conventional external communication functionality such as an internet connection.

Each participant client 121 also typically comprises or is in communication with a computer screen, arranged to display video content provided to the participant client 121 as a part of an ongoing video communication; a loudspeaker, arranged to emit sound content provided to the participant client 121 as a part of said video communication; a video camera; and a microphone, arranged to record sound locally to a human participant 122 to said video communication, the participant 122 using the participant client 121 in question to participate in said video communication.

In other words, a respective human-machine interface of each participating client 121 allows a respective participant 122 to interact with the client 121 in question, in a video communication, with other participants and/or audio/video streams provided by various sources.

In general, each of the participating clients 121 comprises a respective input means 123, that may comprise said video camera; said microphone; a keyboard; a computer mouse or trackpad; and/or an API to receive a digital video stream, a digital audio stream and/or other digital data. The input means 123 is specifically arranged to receive a video stream and/or an audio stream from a central server, such as the video communication service 110 and/or the central server 130, such a video stream and/or audio stream being provided as a part of a video communication and preferably being produced based on corresponding digital data input streams provided to said central server from at least two sources of such digital data input streams, for instance participant clients 121 and/or external sources (see below).

Further generally, each of the participating clients 121 comprises a respective output means 124, that may comprise said computer screen; said loudspeaker; and an API to emit a digital video and/or audio stream, such stream being representative of a captured video and/or audio locally to the participant 122 using the participant client 121 in question.

In practice, each participant client 121 may be a mobile device, such as a mobile phone, arranged with a screen, a loudspeaker, a microphone and an internet connection, the mobile device executing computer software locally or accessing remotely executed computer software to perform the functionality of the participant client 121 in question. Correspondingly, the participant client 121 may also be a thick or thin laptop or stationary computer, executing a locally installed application, using a remotely accessed functionality via a web browser, and so forth, as the case may be.

There may be more than one, such as at least three or even at least four, participant clients 121 used in one and the same video communication of the present type.

There may be at least two different groups of participating clients. Each of the participating clients may be allocated to such a respective group. The groups may reflect different roles of the participating clients, different virtual or physical locations of the participating clients and/or different interaction rights of the participating clients.

Various available such roles may be, for instance, “leader” or “conferencier”, “speaker”, “panel participant”, “interacting audience” or “remote listener”.

Various available such physical locations may be, for instance, “physically in the room”, “listening in remotely”, “on the stage”, “in the panel”, “in the physically present audience” or “in the physically remote audience”.

A virtual location may be defined in terms of the physical location, but may also involve a virtual grouping that may partly overlap with said physical locations. For instance, a physically present audience may be divided into a first and a second virtual group, and some physically present audience participants may be grouped together with some physically distant audience participants in one and the same virtual group.

Various available such interaction rights may be, for instance, “full interaction” (no restrictions), “can talk but only after requesting the microphone” (such as raising a virtual hand in a video conference service), “cannot talk but write in common chat” or “view/listen only”.

In some instances, each role defined and/or physical/virtual location may be defined in terms of certain predetermined interaction rights. In other instances, all participants having the same interaction rights form a group. Hence, any defined roles, locations and/or interaction rights may reflect various group allocations, and different groups may be disjoint or overlapping, as the case may be.

The video communication may be provided at least partly by the video communication service 110 and at least partly by the central server 130, as will be described and exemplified herein.

As the term is used herein, a “video communication” is an interactive, digital communication session involving at least two, preferably at least three or even at least four, video streams, and preferably also matching audio streams that are used to produce one or several mixed or joint digital video/audio streams that in turn is or are consumed by one or several consumers (such as participant clients of the discussed type), that may or may not also be contributing to the video communication via video and/or audio. Such a video communication is real-time, with or without a certain latency or delay. At least one, preferably at least two, or even at least four, participants 122 to such a video communication is involved in the video communication in an interactive manner, both providing and consuming video/audio information.

At least one of the participant clients 121, or all of the participant clients 121, may comprise a local synchronisation software function 125, that will be described in closer detail below.

The video communication service 110 may comprise or have access to a common time reference, as will also be described in closer detail below.

Each of the at least one central server 130 may comprise a respective API 137, for digitally communicating with entities external to the central server 130 in question. Such communication may involve both input and output.

The system 100, such as said central server 130, may furthermore be arranged to digitally communicate with, and in particular to receive digital information, such as audio and/or video stream data, from an external information source 300, such as an externally provided video stream. That the information source 300 is “external” means that it is not provided from or as a part of the central server 130. Preferably, the digital data provided by the external information source 300 is independent of the central server 130, and the central server 130 cannot affect the information contents thereof. For instance, the external information source 130 may be live captured video and/or audio, such as of a public sporting event or an ongoing news event or reporting. The external information source 300 may also be captured by a web camera or similar, but not by any one of the participating clients 121. Such captured video may hence show the same locality as any one of the participant clients 121, but not be captured as a part of the activity of the participant client 121 per se. One possible difference between an externally provided information source 300 and an internally provided information source 120 is that internally provided information sources may be provided as, and in their capacity as, participants to a video communication of the above-defined type, whereas an externally provided information source 300 is not, but is instead provided as a part of a context that is external to said video conference. In other embodiments, one or several externally provided information sources 300 are in the form of a respective digital camera or a microphone, arranged to capture a respective digital image/video and/or audio stream in the same locality in which one or several of the participating clients 121 and/or the corresponding users 122 are present, and in a way which is controlled by the central server 130. Hence, the central server 130 may control an on/off state of such digital image/video/audio capturing device 300, and/or other capturing state such as a currently applied physical or virtual panning or zooming.

There may also be several external information sources 300, that provide digital information of said type, such as audio and/or video streams, to the central server 130 in parallel.

As shown in FIG. 1, each of the participating clients 121 may constitute the source of a respective information (video and/or audio) stream 120, provided to the video communication service 110 by the participating client 121 in question as described.

The system 100, such as the central server 130, may be further arranged to digitally communicate with, and in particular to emit digital information to, an external consumer 150. For instance, a digital video and/or audio stream produced by the central server 130 may be provided continuously, in real-time or near real-time, to one or several external consumers 150 via said API 137. Again, that the consumer 150 is “external” means that the consumer 150 is not provided as a part of the central server 130, and/or that it is not a party to the said video communication.

Unless not stated otherwise, all functionality and communication herein is provided digitally and electronically, effected by computer software executing on suitable computer hardware and communicated over a local or global digital communication network or channel such as the internet.

Hence, in the system 100 configuration illustrated in FIG. 1, a number of participant clients 121 take part in a digital video communication provided by the video communication service 110. Each participant client 121 may hence have an ongoing login, session or similar to the video communication service 110, and may take part in one and the same ongoing video communication provided by the video communication service 110. In other words, the video communication is “shared” among the participant clients 121 and therefore also by corresponding human participants 122.

In FIG. 1, the central server 130 comprises an automatic participant client 140, being an automated client corresponding to participant clients 121 but not associated with a human participant 122. Instead, the automatic participant client 140 is added as a participant client to the video communication service 110 to take part in the same shared video communication as participant clients 121. As such a participant client, the automatic participant client 140 is granted access to continuously produced digital video and/or audio stream(s) provided as a part of the ongoing video communication by the video communication service 110, and can be consumed by the central server 130 via the automatic participant client 140. Preferably, the automatic participant client 140 receives, from the video communication service 110, a common video and/or audio stream that is or may be distributed to each participant client 121; a respective video and/or audio stream provided to the video communication service 110 from each of one or several of the participant clients 121 and relayed, in raw or modified form, by the video communication service 110 to all or requesting participant clients 121; and/or a common time reference.

The central server 130 may comprise a collecting function 131 arranged to receive video and/or audio streams of said type from the automatic participant client 140, and possibly also from said external information source(s) 300, for processing as described below, and then to provide a produced, such as shared, video stream via the API 137. For instance, this produced video stream may be consumed by the external consumer 150 and/or by the video communication service 110 to in turn be distributed by the video communication service 110 to all or any requesting one of the participant clients 121.

FIG. 2 is similar to FIG. 1, but instead of using the automatic client participant 140 the central server 130 receives video and/or audio stream data from the ongoing video communication via an API 112 of the video communication service 110.

FIG. 3 is also similar to FIG. 1, but shows no video communication service 110. In this case, the participant clients 121 communicate directly with the API 137 of the central server 130, for instance providing video and/or audio stream data to the central server 130 and/or receiving video and/or audio stream data from the central server 130. Then, the produced shared stream may be provided to the external consumer 150 and/or to one or several of the client participants 121.

FIG. 4 illustrates the central server 130 in closer detail. As illustrated, said collecting function 131 may comprise one or, preferably, several, format-specific collecting functions 131a. Each one of said format-specific collecting functions 131a may be arranged to receive a video and/or audio stream having a predetermined format, such as a predetermined binary encoding format and/or a predetermined stream data container, and may be specifically arranged to parse binary video and/or audio data of said format into individual video frames, sequences of video frames and/or time slots.

The central server 130 may further comprise an event detection function 132, arranged to receive video and/or audio stream data, such as binary stream data, from the collecting function 131 and to perform a respective event detection on each individual one of the received data streams. The event detection function 132 may comprise an AI (Artificial Intelligence) component 132a for performing said event detection. The event detection may take place without first time-synchronising the individual collected streams.

The central server 130 further comprises a synchronising function 133, arranged to time-synchronise the data streams provided by the collecting function 131 and that may have been processed by the event detection function 132. The synchronising function 133 may comprise an AI component 133a for performing said time-synchronisation.

The central server 130 may further comprise a pattern detection function 134, arranged to perform a pattern detection based on the combination of at least one, but in many cases at least two, such as at least three or even at least four, such as all, of the received data streams. The pattern detection may be further based on one, or in some cases at least two or more, events detected for each individual one of said data streams by the event detection function 132. Such detected events taking into consideration by said pattern detection function 134 may be distributed across time with respect to each individual collected stream. The pattern detection function 134 may comprise an AI component 134a for performing said pattern detection. The pattern detection may further be based on the above-discussed grouping, and in particular be arranged to detect a particular pattern occurring only with respect to one group; with respect to only some but not all groups; or with respect to all groups.

The central server 130 further comprises a production function 135, arranged to produce a produced digital video stream, such as a shared digital video stream, based on the data stream or streams provided from the collecting function 131, and possibly further based on any detected events and/or patterns. Such a produced video stream may at least comprise a video stream produced to comprise one or several of video streams provided by the collecting function 131, raw, reformatted or transformed, and may also comprise corresponding audio stream data. As will be exemplified below, there may be several produced video streams, where one such produced video stream may be produced in the above-discussed way but further based on a another already produced video stream.

All produced video streams are preferably produced continuously, and preferably in near real-time (after discounting any latencies and delays of the types discussed hereinbelow).

The central server 130 may further comprise a publishing function 136, arranged to publish the produced digital video stream in question, such as via API 137 as described above.

It is noted that FIGS. 1, 2 and 3 illustrate three different examples of how the central server 130 can be used to implement the principles described herein, and in particular to provide a method according to the present invention, but that other configurations, with or without using one or several video communication services 110, are also possible.

FIG. 5 illustrates a method for providing a produced digital video stream. FIGS. 6a-6f illustrates different digital video/audio data stream states resulting from the method steps illustrated in FIG. 5.

In a first step S500, the method starts.

In a subsequent collecting step S501, respective primary digital video streams 210, 301 are collected, such as by said collecting function 131, from at least two of said digital video sources 120, 300. Each such primary data stream 210, 301 may comprise an audio part 214 and/or a video part 215. It is understood that “video”, in this context, refers to moving and/or still image contents of such a data stream. Each primary data stream 210, 301 may be encoded according to any video/audio encoding specification (using a respective codec used by the entity providing the primary stream 210, 301 in question), and the encoding formats may be different across different ones of said primary streams 210, 301 concurrently used in one and the same video communication. It is preferred that at least one, such as all, of the primary data streams 210, 301 is provided as a stream of binary data, possibly provided in a per se conventional data container data structure. It is preferred that at least one, such as at least two, or even all of the primary data streams 210, 301 are provided as respective live video recordings.

It is noted that the primary streams 210, 301 may be unsynchronised in terms of time when they are received by the collecting function 131. This may mean that they are associated with different latencies or delays in relation to each other. For instance, in case two primary video streams 210, 301 are live recordings, this may imply that they are associated, when received by the collecting function 131, with different latencies with respect to the time of recording.

It is also noted that the primary streams 210, 301 may themselves be a respective live camera feed from a web camera; a currently shared screen or presentation; a viewed film clip or similar; or any combination of these arranged in various ways in one and the same screen.

The collecting step S501 is shown in FIGS. 6a and 6b. In FIG. 6a, it is also illustrated how the collecting function 131 can store each primary video stream 210, 301 as bundled audio/video information or as audio stream data separated from associated video stream data. FIG. 6b illustrates how the primary video stream 210, 301 data is stored as individual frames 213 or collections/clusters of frames, “frames” here referring to time-limited parts of image data and/or any associated audio data, such as each frame being an individual still image or a consecutive series of images (such as such a series constituting at the most 1 second of moving images) together forming moving-image video content.

In a subsequent event detection step S502, performed by the event detection function 132, said primary digital video streams 210, 301 are analysed, such as by said event detection function 132, for instance said AI component 132a, to detect at least one event 211 selected from a first set of events. This is illustrated in FIG. 6c.

It is preferred that this event detection step S502 may be performed for at least one, such as at least two, such as all, primary video streams 210, 301, and that it may be performed individually for each such primary video stream 210, 301. In other words, the event detection step S502 preferably takes place for said individual primary video stream 210, 301 only taking into consideration information contained as a part of that particular primary video stream 210, 301 in question, and particularly without taking into consideration information contained as a part of other primary video streams. Furthermore, the event detection preferably takes place without taking into consideration any common time reference 260 associated with the several primary video streams 210, 301.

On the other hand, the event detection preferably takes into consideration information contained as a part of the individually analysed primary video stream in question across a certain time interval, such as a historic time interval of the primary video stream that is longer than 0 seconds, such as at least 0.1 seconds, such as at least 1 second.

The event detection may take into consideration information contained in audio and/or video data contained as a part of said primary video stream 210, 301.

Said first set of events may contain any number of types of events, such as a change of slides in a slide presentation constituting or being a part of the primary video stream 210, 301 in question; a change in connectivity quality of the source 120, 300 providing the primary video stream 210, 301 in question, resulting in an image quality change, a loss of image data or a regain of image data; and a detected movement physical event in the primary video stream 210, 301 in question, such as the movement of a person or object in the video, a change of lighting in the video, a sudden sharp noise in the audio or a change of audio quality. It is realised that this is not intended to be an exhaustive list, but that these examples are provided in order to understand the applicability of the presently described principles.

In a subsequent synchronising step S503, performed by the synchronisation function 133, the primary digital video streams 210 may be time-synchronised. This time-synchronisation may be with respect to a common time reference 260. As illustrated in FIG. 6d, the time-synchronisation may involve aligning the primary video streams 210, 301 in relation to each other, for instance using said common time reference 260, so that they can be combined to form a time-synchronised context. The common time reference 260 may be a stream of data, a heartbeat signal or other pulsed data, or a time anchor applicable to each of the individual primary video streams 210, 301. The common time reference can be applied to each of the individual primary video streams 210, 301 in a way so that the informational contents of the primary video stream 210, 301 in question can be unambiguously related to the common time reference with respect to a common time axis. In other words, the common time reference may allow the primary video streams 210, 301 to be aligned, via time shifting, so as to be time-synchronised in the present sense. In other embodiments, the time-synchronisation may be based on known information about a time difference between the primary video streams 210, 301 in question, such as based on measurements.

As illustrated in FIG. 6d, the time-synchronisation may comprise determining, for each primary video streams 210, 301, one or several timestamps 261, such as in relation to the common time reference 260 or for each video stream 210, 301 in relation to another video stream 210, 301 or to other video streams 210, 301.

In a subsequent pattern detection step S504, performed by the pattern detection function 134, the hence time-synchronised primary digital video streams 210, 301 are analysed to detect at least one pattern 212 selected from a first set of patterns. This is illustrated in FIG. 6e.

In contrast to the event detection step S502, the pattern detection step S504 may be performed based on video and/or audio information contained as a part of at least two of the time-synchronised primary video streams 210, 301 considered jointly.

Said first set of patterns may contain any number of types of patterns, such as several participants talking interchangeably or concurrently; or a presentation slide change occurring concurrently as a different event, such as a different participant talking. This list is not exhaustive, but illustrative.

In some embodiments, detected patterns 212 may relate not to information contained in several of said primary video streams 210, 301 but only in one of said primary video streams 210, 301. In such cases, it is preferred that such pattern 212 is detected based on video and/or audio information contained in that single primary video stream 210, 301 spanning across at least two detected events 211, for instance two or more consecutive detected presentation slide changes or connection quality changes. As an example, several consecutive slide changes that follow on each other rapidly over time may be detected as one single slide change pattern, as opposed to one individual slide change pattern for each detected slide change event. Other examples include the movement of a shown entity or person; and the recognition of an uttered vocal phrase by a participating user.

It is realised that the first set of events and said first set of patterns may comprise events/patterns being of predetermined types, defined using respective sets of parameters and parameter intervals. As will be explained below, the events/patterns in said sets may also, or additionally, be defined and detected using various AI tools.

In a subsequent production step S505, performed by the production function 135, a shared digital video stream is produced as an output digital video stream 230 based on consecutively considered frames 213 of the possibly time-synchronised primary digital video streams 210, 301, and further based on said detected events 211 and/or said detected patterns 212.

As will be explained and detailed in the following, the present invention allows for the completely automatic production of video streams, such as of the output digital video stream 230.

For instance, such production may involve the selection of what video and/or audio information from what primary video stream 210, 301 to use to what extent in such output video stream 230; a video screen layout of an output video stream 230; a switching pattern between different such uses or layouts across time; and so forth.

This is illustrated in FIG. 6f, that also shows one or several additional pieces of time-related (that may be related to the common time reference 260) digital video information 220, such as an additional digital video information stream, that can be time-synchronised (such as to said common time reference 260) and used in concert with the time-synchronised primary video streams 210, 301 in the production of the output video stream 230. For instance, the additional stream 220 may comprise information with respect to any video and/or audio special effects to use, such as dynamically based on detected patterns; a planned time schedule for the video communication; and so forth.

In a subsequent publishing step S506, performed by the publishing function 136, the produced output digital video stream 230 is continuously provided to a consumer 110, 150 of the produced digital video stream as described above. The produced digital video stream may be provided to one or several participant clients 121, such as via the video communication service 110.

In a subsequent step S507, the method ends. However, first the method may iterate any number of times, as illustrated in FIG. 5, to produce the output video stream 230 as a continuously provided stream. Preferably, the output video stream 230 is produced to be consumed in real-time or near real-time (taking into consideration a total latency added by all steps along the way), and continuously (publishing taking place immediately when more information is available, however not counting any deliberately added latencies or delays, see below). This way, the output video stream 230 may be consumed in an interactive manner, so that the output video stream 230 may be fed back into the video communication service 110 or into any other context forming a basis for the production of a primary video stream 210 again being fed to the collection function 131 so as to form a closed feedback loop; or so that the output video stream 230 may be consumed into a different (external to system 100 or at least external to the central server 130) context but there forming the basis of a real-time, interactive video communication.

As mentioned above, in some embodiments at least two, such as at least three, such as at least four, or even at least five, of said primary digital video streams 210, 301 are provided as a part of a shared digital video communication, such as provided by said video communication service 110, the video communication involving a respective remotely connected participant client 121 providing the primary digital video stream 210 in question. In such cases, the collecting step S501 may comprise collecting at least one of said primary digital video streams 210 from the shared digital video communication service 110 itself, such as via an automatic participant client 140 in turn being granted access to video and/or audio stream data from within the video communication service 110 in question; and/or via an API 112 of the video communication service 110.

Moreover, in this and in other cases the collecting step S501 may comprise collecting at least one of said primary digital video streams 210, 301 as a respective external digital video stream 301, collected from an information source 300 being external to the shared digital video communication service 110. It is noted that one or several used such external video sources 300 may also be external to the central server 130.

In some embodiments, the primary video streams 210, 301 are not formatted in the same manner. Such different formatting can be in the form of them being delivered to the collecting function 131 in different types of data containers (such as AVI or MPEG), but in preferred embodiments at least one of the primary video streams 210, 301 is formatted according to a deviating format (as compared to at least one other of said primary video streams 210, 301) in terms of said deviating primary digital video stream 210, 301 having a deviating video encoding; a deviating fixed or variable frame rate; a deviating aspect ratio; a deviating video resolution; and/or a deviating audio sample rate.

It is preferred that the collecting function 131 is preconfigured to read and interpret all encoding formats, container standards, etc. that occur in all collected primary video streams 210, 301. This makes it possible to perform the processing as described herein, not requiring any decoding until relatively late in the process (such as not until after the primary stream in question is put in a respective buffer; not until after the event detection step S502; or even not until after the event detection step S502). However, in the rare case in which one or several of the primary video feeds 210, 301 are encoded using a codec that the collecting function 131 cannot interpret without decoding, the collecting function 131 may be arranged to perform a decoding and analysis of such primary video stream 210, 301, followed by a conversion into a format that can be handled by, for instance, the event detection function. It is noted that, even in this case, it is preferred not to perform any reencoding at this stage.

For instance, primary video streams 220 being fetched from multi-party video events, such as one provided by the video communication service 110, typically have requirements on low latency and are therefore typically associated with variable framerate and variable pixel resolution to enable participants 122 to have an effective communication. In other words, overall video and audio quality will be decreased as necessary for the sake of low latency.

External video feeds 301, on the other hand, will typically have a more stable framerate, higher quality but therefore possibly higher latency.

Hence, the video communication service 110 may, at each moment in time, use a different encoding and/or container than the external video source 300. The analysis and video production process described herein in this case therefore needs to combine these streams 210, 301 of different formats into a new one for the combined experience.

As mentioned above, the collecting function 131 may comprise a set of format-specific collecting functions 131a, each one arranged to process a primary video stream 210, 301 of a particular type of format. For instance, each one of these format-specific collecting functions 131a may be arranged to process primary video streams 210, 301 having been encoded using a different video respective encoding method/codec, such as Windows® Media® or DivX®.

However, in some embodiments the collecting step S501 comprises converting at least two, such as all, of the primary digital video streams 210, 301 into a common protocol 240.

As used in this context, the term “protocol” refers to an information-structuring standard or data structure specifying how to store information contained in a digital video/audio stream. The common protocol preferably does not, however, specify how to store the digital video and/or audio information as such on a binary level (i.e. the encoded/compressed data instructive of the sounds and images themselves), but instead forms a structure of predetermined format for storing such data. In other words, the common protocol prescribes storing digital video data in raw, binary form without performing any digital video decoding or digital video encoding in connection to such storing, possibly by not at all amending the existing binary form apart from possibly concatenating and/or splitting apart the binary form byte sequence. Instead, the raw (encoded/compressed) binary data contents of the primary video stream 210, 301 in question is kept, while repacking this raw binary data in the data structure defined by the protocol. In some embodiments, the common protocol defines a video file container format.

FIG. 7 illustrates, as an example, the primary video streams 210, 301 shown in FIG. 6a, restructured by the respective format-specific collecting function 131a and using said common protocol 240.

Hence, the common protocol 240 prescribes storing digital video and/or audio data in data sets 241, preferably divided into discreet, consecutive sets of data along a time line pertaining to the primary video stream 210, 301 in question. Each such data set may include one or several video frames, and also associated audio data.

The common protocol 240 may also prescribe storing metadata 242 associated with specified time points in relation to the stored digital video and/or audio data sets 241.

The metadata 242 may comprise information about the raw binary format of the primary digital video stream 210 in question, such as regarding a digital video encoding method or codec used to produce said raw binary data; a resolution of the video data; a video frame rate; a frame rate variability flag; a video resolution; a video aspect ratio; an audio compression algorithm; or an audio sampling rate. The metadata 242 may also comprise information on a timestamp of the stored data, such as in relation to a time reference of the primary video stream 210, 301 in question as such or to a different video stream as discussed above.

Using said format-specific collecting functions 131a in combination with said common protocol 240 makes it possible to quickly collect the informational contents of the primary video streams 210, 301 without adding latency by decoding/reencoding the received video/audio data.

Hence, the collecting step S501 may comprise using different ones of said format-specific collecting functions 131a for collecting primary digital video streams 210, 301 being encoded using different binary video and/or audio encoding formats, in order to parse the primary video stream 210, 301 in question and store the parsed, raw and binary data in a data structure using the common protocol, together with any relevant metadata. Self-evidently, the determination as to what format-specific collecting function 131a to use for what primary video stream 210, 301 may be performed by the collecting function 131 based on predetermined and/or dynamically detected properties of each primary video stream 210, 301 in question.

Each hence collected primary video stream 210, 301 may be stored in its own separate memory buffer, such as a RAM memory buffer, in the central server 130.

The converting of the primary video streams 210, 301 performed by each format-specific collecting function 131a may hence comprise splitting raw, binary data of each thus converted primary digital video stream 210, 301 into an ordered set of said smaller sets of data 241.

Moreover, the converting may also comprise associating each (or a subset, such as a regularly distributed subset along a respective time line of the primary stream 210, 301 in question) of said smaller sets 241 with a respective time along a shared time line, such as in relation to said common time reference 260. This associating may be performed by analysis of the raw binary video and/or audio data in any of the principle ways described below, or in other ways, and may be performed in order to be able to perform the subsequent time-synchronising of the primary video streams 210, 301. Depending on the type of common time reference used, at least part of this association of each of the data sets 241 may also or instead be performed by the synchronisation function 133. In the latter case, the collecting step S501 may instead comprise associating each, or a subset, of the smaller sets 241 with a respective time of a time line specific for the primary stream 210, 301 in question.

In some embodiments, the collecting step S501 also comprises converting the raw binary video and/or audio data collected from the primary video streams 210, 301 into a uniform quality and/or updating frequency. This may involve down-sampling or up-sampling of said raw, binary digital video and/or audio data of the primary digital video streams 210, 301, as necessary, to a common video frame rate; a common video resolution; or a common audio sampling rate. It is noted that such re-sampling can be performed without performing a full decoding/reencoding, or even without performing any decoding at all, since the format-specific collecting function 131a in question can process the raw binary data directly according to the correct binary encoding target format.

Each of said primary digital video streams 210, 301 may be stored in an individual data storage buffer 250, as individual frames 213 or sequences of frames 213 as described above, and also each associated with a corresponding time stamp in turn associated with said common time reference 260.

In a concrete example, provided to illustrate these principles, the video communication service 110 is Microsoft® Teams®, running a video conference involving concurrent participants 122. The automatic participant client 140 is registered as a meeting participant in the Teems® meeting.

Then, the primary video input signals 210 are available to and obtained by the collecting function 130 via the automatic participant client 140. These are raw signals in H264 format and contain timestamp information for every video frame.

The relevant format-specific collecting function 131a picks up the raw data over IP (LAN network) on a configurable predefined TCP port. Every Teems® meeting participant, as well as associated audio data, are associated with a separate port. The collecting function 131 then uses the timestamps from the audio signal (which is in 50 Hz) and down-samples the video data to a fixed output signal of 25 Hz before storing the video stream 220 in its respective individual buffer 250.

As mentioned, the common protocol 240 may store the data in raw binary form. It can be designed to be very low-level, and to handle the raw bits and bytes of the video/audio data. In preferred embodiments, the data is stored in the common protocol 240 as a simple byte array or corresponding data structure (such as a slice). This means that the data does not need to be put in a conventional video container at all (said common protocol 240 not constituting such conventional container in this context). Also, encoding and decoding video is computationally heavy, which means it causes delays and requires expensive hardware. Moreover, this problem scales with the number of participants.

Using the common protocol 240, it becomes possible to reserve memory in the collecting function 131 for the primary video stream 210 associated with each Teams® meeting participant 122, and also for any external video sources 300, and then to change the amount of memory allocated on the fly during the process. This way, it becomes possible to change the number of input streams and as a result keep each buffer effective. For instance, since information like resolution, framerate and so forth may be variable but stored as metadata in the common protocol 240, this information can be used to quickly resize each buffer as need may be.

The following is an example of a specification of a common protocol 240 of the present type:

| Bytes | Example | Description |
|---|---|---|
| 1 byte | 1 | 0 = video; 1 = audio |
| 4 bytes | 1234567 | Buffer Length (int) |
| 8 bytes | 424234234 | Timestamp from the incoming |
| | | audio/video buffer |
| | | Measured in ticks, 1 tick = 100 |
| | | ns. (long int) |
| 1 byte | 0 | VideoColorFormat |
| | | { |
| | | NV12 = 0, |
| | | Rgb24 = 1, |
| | | Yuy2 = 2, |
| | | H264 = 3 |
| | | } |
| 4 bytes | 720 | Video frame pixel height (int) |
| 4 bytes | 640 | Video frame pixel width (int) |
| 4 bytes | 25.0 | Video frame rate |
| | | Number of frames per second (float) |
| 1 byte | 0 | Is audio silence? 1 = true; 0 = false |
| 1 byte | 0 | AudioFormat |
| | | { |
| | | 0 = Pcm16K |
| | | 1 = Pcm44KStereo |
| | | } |
| 1 byte | 0 | Detected event in, if any |
| | | 0 = no event |
| | | 1, 2, 3, etc. = event of specified type |
| | | detected |
| 30 bytes | | Reserved for future use |
| 8 bytes | 1000000 | Length of binary data in bytes |
| | | (long int) |
| Variable | 0x87A879 . . . | Raw binary video/audio data of this |
| | | frame(s) |
| 4 bytes | 1234567 | Dominant speaker Port |
| 4 bytes | 1234567 | Active speaker |

Above, the “Detected event in, if any” data is included as a part of the common protocol 260 specification. However, in some embodiments, this information (regarding detected events) may instead be put in a separate memory buffer.

In some embodiments, said at least one additional piece of digital video information 220, that may be an overlay or an effect, is also stored in a respective individual buffer 250, as individual frames or sequences of frames each associated with a corresponding time stamp in turn associated with said common time reference 260.

As exemplified above, the event detection step S502 may comprise storing, using said common protocol 240, metadata 242 descriptive of a detected event 211, associated with the primary digital video stream 210, 301 in which the event 211 in question was detected.

The event detection can be performed in different ways. In some embodiments, performed by the AI component 132a, the event detection step S502 comprises a first trained neural network or other machine learning component analysing at least one, such as several or even all, of said primary digital video streams 210, 301 individually in order to automatically detect any of said events 211. This may involve the AI component 132a classifying, in a managed classification, the primary video stream 210, 301 data into a set of predefined events and/or, in an unmanaged classification, into a dynamically determined set of events.

In some embodiments, the detected event 211 is a change of presentation slides in a presentation being or being comprised in the primary video stream 210, 301 in question.

For instance, if the presenter of the presentation decides to change the slide in the presentation he/she is giving at that time to an audience, this means that what is interesting for a given viewer can change. It may be that the newly shown slide is only a high level picture that can best be seen briefly in a so-called “butterfly” mode (for instance, displaying in the output video stream 230 the slide side-by-side with a video of the presenter). Alternatively, the slide may contain much detail, text with small font sizes, and so forth. In this latter case, the slide should instead be presented in full-screen and perhaps during a somewhat longer time period than what is usually the case. A butterfly mode may not be as appropriate, since the slide in this case may be more interesting to a viewer of the presentation than the face of the presenter.

In practice, the event detection step S502 may comprise at least one of the following:

Firstly, the event 211 can be detected based on an image analysis of a difference between a first image of a detected slide and a subsequent second image of a detected slide. The nature of the primary video stream 220, 301 being that of showing a slide can be automatically determined using per se conventional digital image processing, such as using motion detection in combination with OCR (Optical Character Recognition).

This may involve checking, using automatic computer image processing techniques, whether the detected slide has changed significantly enough to actually categorise it as a slide change. This may be done by checking the delta between current slide and previous slide with respect to RGB colour values. For instance, one may assess how much the RGB values have changed globally in the screen area covered by the slide in question, and whether it is possible to find groups of pixels that belong together and that change in concert. This way, relevant slide changes can be detected while, for instance, filtering out irrelevant changes such as shown computer mouse movements across the screen. This approach also allows full configurability—for instance, sometimes it is desired to be able to capture computer mouse movement, for instance when the presenter wishes to present something in detail using the computer mouse to point to different things.

Secondly, the event 211 may be detected based on an image analysis of an informational complexity of said second image itself, to determine the type of event with greater specificity.

This may, for instance, involve assessing a total amount of textual information on the slide in question, as well as associated font sizes. This may be done by using conventional OCR methods, such as deep learning-based character recognition techniques.

It is noted that, since the raw binary format of the assessed video stream 210, 301 is known, this may be performed directly in the binary domain, without first decoding or reencoding the video data. For instance, the event detection function 132 may call the relevant format-specific collecting function for image interpreting services, or the event detection function 132 may itself include functionality for assessing image information, such as on individual pixel level, for a number of different supported raw binary video data formats.

In another example, the detected event 211 is a loss of communication connection of a participant client 121 to a digital video communication service 110. Then, the detection step S502 may comprise detecting that said participant client 121 has lost communication connection based on an image analysis of a series of subsequent video frames 213 of a primary digital video stream 210 corresponding to the participant client 121 in question.

Because participant clients 121 may be associated with different physical locations and different internet connections, it can happen that someone will lose connection to the video communication service 110 or to the central server 130. In that situation, it is desirable to avoid showing a black or empty screen in the produced output video stream 230.

Instead, such connection loss can be detected as an event by the event detection function 132, such as by applying a 2-class classification algorithm where the 2 classes used are connected/not connected (no data). In this case, it is understood that “no data” differs from the presenter sending out a black screen intentionally. Because a brief black screen, such as of only 1 or 2 frames, may not be noticeable in the end production stream 230, one may apply said 2-class classification algorithm over time to create a time series. Then, a threshold value, specifying a minimum length for a connection interruption, can be used to decide whether there is a lost connection or not.

In another example, the event is the detection of a presence or movement of a participating human user in one or several images of said primary digital video stream 210, 301. In another example, the event is the detection of a movement (such as rotation, zoom, pan, etc.) of a camera used to produce said primary digital video stream 210, 301, possibly including information about a general movement component and/or a noise movement component of such movement. The noise movement component may, for instance, be due to the camera being moved manually. Such detection of a presence/movement of a human user, and/or a detection of a movement of said camera, may be achieved using per se conventional digital image processing techniques, for instance as has been exemplified above.

As will be explained in the following, detected events of these exemplified types may be used by the pattern detection function 134 to take various actions, as suitable and desired.

As mentioned, the individual primary video streams 210, 301 may each be related to the common time reference 260 or to each other in the time domain, making it possible for the synchronisation function 133 to time-synchronise them in relation to each other.

In some embodiments, the common time reference 260 is based on or comprises a common audio signal 111 (see FIGS. 1-3), the common audio signal 111 being common for the shared digital video communication service 110 involving at least two remotely connected participant clients 121 as described above, each providing a respective one of said primary digital video streams 210.

In the example of Microsoft® Teams® discussed above, a common audio signal is produced and can be captured by the central server 130 via the automatic participant client 140 and/or via the API 112. In this and in other examples, such a common audio signal may be used as a heartbeat signal to time-synchronise the individual primary video streams 220 by binding each of these to specific time points based on this heartbeat signal. Such a common audio signal may be provided as a separate (in relation to each of the other primary video streams 210) signal, whereby the other primary video streams 210 may each be individually time-correlated to the common audio signal, based on audio contained in the other primary video stream 210 in question or even based on image information contained therein (such as using automatic image processing-based lip syncing techniques).

In other words, to handle any variable and/or differing latency associated with individual primary video streams 210, and to achieve time-synchronisation for the combined video output stream 230, such a common audio signal may be used as a heartbeat for all primary video streams 210 in the central server 130 (but perhaps not external primary video streams 301). In other words, all other signals may be mapped to this common audio time heartbeat to make sure that everything is in time sync.

In a different example, the time-synchronisation is achieved using a time synchronisation element 231 introduced into the output digital video stream 230 and detected by a respective local time-synchronising software function 125 provided as a part of one or several individual ones of the participant clients 121, the local software function 125 being arranged to detect a time of arrival of the time synchronisation element 231 in the output video stream 230. As is understood, in such embodiments the output video stream 230 is fed back into the video communication service 110 or otherwise made available to each participant client 121 and the local software function 125 in question.

For instance, the time synchronisation element 231 may be a visual marker, such as a pixel changing colours in a predetermined sequence or manner, placed or updated in the output video 230 at regular time intervals; a visual clock updated and displayed in the output video 230; a sound signal (that may be designed to be non-audible to participants 122 by, for instance, having low enough amplitude and/or high enough frequency) and added to an audio forming part of the output video stream 230. The local software function 125 is arranged to, using suitable image and/or audio processing, automatically detect respective times of arrival of each of the (or each of the) time synchronisation element(s) 231.

Then, the common time reference 260 may be determined at least party based on said detected times of arrival. For instance, each of the local software functions 125 may communicate to the central server 130 respective information signifying said detected time of arrival.

Such communication may take place via a direct communication link between the participant client 121 in question and the central server 130. However, the communication may also take place via the primary video stream 210 associated with the participant client 121 in question. For instance, the participating client 121 may introduce a visual or audible code, such as of the above discussed type, in the primary video stream 210 produced by that participant client 121 in question, for automatic detection by the central server 130 and used to determine the common time reference 260.

In yet additional examples, each participant client 121 may perform an image detection in a common video stream available for viewing by all participant clients 121 to the video communication service 110 and relay the results of such image detection to the central server 130, in a way corresponding to the ones discussed above, to there be used to over time determine respective offsets of each participant client 121 in relation to each other. This way, a common time reference 260 may be determined as a set of individual relative offsets. For instance, a selected reference pixel of a commonly available video stream may be monitored by several, or all, participating clients 121, such as by said local software function 125, and a current colour of that pixel may be communicated to the central server 130. The central server 130 may calculate a respective time series based on consecutively received such colour values from each of a number of (or all) the participant clients 121, and perform a cross-correlation resulting in an estimated set of relative time offsets across the different participant clients 121.

In practice, the output video stream 230 fed into the video communication service 110 may be included as a part of a shared screen to every participant client of the video communication in question, and may therefore be used to assess such time offset associated with the participant clients 121. In particular, the output video stream 230 fed to the video communication service 110 may be available again to the central server via the automatic participant client 140 and/or the API 112.

In some embodiments, a common time reference 260 may be determined at least partly based on a detected discrepancy between an audio part 214 of a first one of said primary digital video streams 210, 301 and an image part 215 of said first primary digital video streams 210, 301. Such discrepancy may, for instance, be based on a digital lip sync video image analysis of a talking participant 122 viewed in said first primary digital video stream 210, 301 in question. Such lip sync analysis is conventional as such, and may for instance use a trained neural network. The analysis may be performed by the synchronisation function 133 for each primary video stream 210, 301 in relation to available common audio information, and relative offsets across the individual primary video streams 210, 301 may be determined based on this information.

In some embodiments, the synchronisation step S503 comprises deliberately introducing a delay (in this context the terms “delay” and “latency” are intended to mean the same thing) of at the most 30 seconds, such as at the most 5 seconds, such as at the most 1 seconds, such as at the most 0.5 seconds, but longer than 0 s, so that the output digital video stream 230 is provided at least with said delay. At any rate, the deliberately introduced delay is at least several video frames, such as at least three, or even at least five or even 10, video frames, such as this number of frames (or individual images) stored after any resampling in the collecting step S501. As used herein, the term “deliberately” means that the delay is introduced irrespective of any need for introducing such a delay based on synchronisation issues or similar. In other words, the deliberately introduced delay is introduced in addition to any delay introduced as a part of the synchronisation of the primary video streams 210, 301 in order to time-synchronise them one in relation to the other. The deliberately introduced delay may be predetermined, fixed or variable in relation to the common time reference 260. The delay time may be measured in relation to a least latent one of the primary video streams 210, 301, so that more latent ones of these streams 210, 301 as a result of said time-synchronisation are associated with a relatively smaller deliberately added delay.

In some embodiments, a relatively small delay is introduced, such as of 0.5 seconds or less. This delay will barely be noticeable by participants to a video communication service 110 using the output video stream 230. In other embodiments, such as when the output video stream 230 will not be used in an interactive context but is instead published in a one-way communication to an external consumer 150, a larger delay may be introduced.

This deliberately introduced delay may be enough so as to achieve sufficient time for the synchronisation function 133 to map the collected individual primary stream 210, 301 video frames onto the correct common time reference 260 timestamp 261. It may also be enough so as to allow sufficient time to perform the event detection described above, in order to detect lost primary stream 210, 301 signals, slide changes, resolution changes, and so forth. Furthermore, deliberately introducing said delay may be enough so as to allow for an improved pattern detection function 134, as will be described in the following.

It is realized that the introduction of said delay may involve buffering 250 each of the collected and time-synchronised primary video streams 210, 301 before publishing the output video stream 230 using the buffered frames 213 in question. In other words, video and/or audio data of at least one, several or even all of the primary video streams 210, 301 may then be present in the central server 130 in a buffered manner, much like a cache but not (like a conventional cache buffer) used with the intention of being able to handle varying bandwidth situations but for the above reasons, and in particular to be used by the pattern detection function 134.

In some embodiments said pattern detection step S504 comprises taking into consideration certain information of at least one, such as several, such as at least four, or even all, of the primary digital video streams 210, 301, the certain information being present in a later frame 213 than a frame of a time-synchronised primary digital video stream 210 yet to be used in the production of the output digital video stream 230. Hence, a newly added frame 213 will exist in the buffer 250 in question during a particular latency time before forming part of (or basis for) the output video stream 230. During this time period, the information in the frame 213 in question will constitute information in the “future” in relation to a currently used frame to produce a current frame of the output video stream 230. Once the output video stream 230 timeline reaches the frame in question 213, it will be used for the production of the corresponding frame of the output video stream 230, and may thereafter be discarded.

In other words, the pattern detection function 134 has at its disposal a set of video/audio frames 213 that have still not been used to produce the output video stream 230, and may use this data to detect said patterns.

The pattern detection can be performed in different ways. In some embodiments, performed by the AI component 134a, the pattern detection step S504 comprises a second trained neural network or other machine learning component analysing at least two, such as at least three, such as at least four, or even all, of said primary digital video streams 120, 301 in concert to automatically detect said pattern 212.

In some embodiments, the detected pattern 212 comprises a speaking pattern involving at least two, such as at least three, such as at least four, different speaking participants 122, each associated with a respective participant client 121, to the shared video communication service 110, each of said speaking participants 122 possibly being viewed visually in a respective one of said primary digital video streams 210, 301.

The production step S505 preferably comprises determining, keeping track of and updating a current production state of the output video stream 230. For instance, such a state can dictate what, if any, participants 122 are visible in the output video stream 230, and where on the screen; if any external video stream 300 is visible in the output video stream 230, and where on the screen; if any slides or shared screens are shown in full-screen mode or in combination with any live video streams; and so on. Furthermore, such a state can dictate any cropping or virtual panning/zooming of any one of the primary digital video streams 210, 301 to be used at any one instance. Hence, the production function 135 can be viewed as a state machine with respect to the produced output video stream 230.

To generate the output video stream 230 as a combined video experience to be viewed by, for instance, an end consumer 150, it is advantageous for the central server 130 to be able to understand what happens on a deeper level than merely detecting individual events associated with individual primary video streams 210, 301.

In a first example, a presenting participant client 121 is changing a currently viewed slide. This slide change is detected by the event detection function 132 as described above, and metadata 242 is added to the frame in question indicative of a slide change having happened. This happens a number of times, since the presenting participating client 121 turns out to skip a number of slides forward in rapid succession, resulting in a series of “slide change” events detected by the even detection function 132 and stored with corresponding metadata 242 in the individual buffer 250 for the primary video stream 210 in question. In practice, each such rapidly forward skipped slide may be visible for only a fraction of a second.

The pattern detection function 134, looking at the information in the buffer 250 in question, spanning across several of these detected slide changes, will detect a pattern corresponding to one single slide change (that is, to the last slide in the forward-skipping, the slide remining visible once the rapid skipping is finished), rather than a number or rapidly performed slide changes. In other words, the pattern detection function 134 will note that there are, for instance, ten slide changes in a very short period of time, why they will be handled as a detected pattern signifying one single slide change. As a result, the production function 135, having access to the patterns detected by the pattern detection function 134, may choose to show the final slide in full-screen mode in the output video stream 230 for a couple of seconds, since it determines this slide to be potentially important in said state machine. It may also choose not to show the intermediately viewed slides at all in the output stream 230.

The detection of the pattern with several rapidly changing slides may be detected by a simple rule-based algorithm, but may alternatively be detected using a trained neural network designed and trained to detect such patterns in moving images by classification.

In a different example, that may for instance be useful in case the video communication is a talk show, panel debate or similar, it may be desirable to quickly switch visual attention between, one the one hand, a current speaker, while, on the other hand, still giving the consumer 150 a relevant viewing experience by producing and publishing a calm and smooth output video stream 230. In this case, the event detection function 132 can continuously analyse each primary video stream 210, 301 to at all times determine whether or not a person being viewed in that particular primary video stream 210, 301 is currently speaking or not. This may, for instance, be performed as described above, using per se conventional image processing tools. Then, the pattern detection function 134 may be operable to detect particular overall patterns, involving several of said primary video streams 210, 301, said patterns being useful for producing a smooth output video stream 230. For instance, the pattern detection function 134 may detect a pattern of very frequent switches between a current speaker and/or patterns involving several concurrent speakers.

Then, the production function 135 can take such detected patterns into consideration when taking automated decisions in relation to said production state, for instance by not automatically switching visual focus to a speaker who only speaks for half a second before again going silent, or to switch to a state where several speakers are displayed side by side during a certain time period when both are speaking interchangeably or concurrently. This state decision process may in itself be performed using time series pattern recognition techniques, or using a trained neural network, but can also be based at least partly on a predetermined set of rules.

In some embodiments, there may be multiple patterns detected in parallel and forming input to the production function 135 state machine. Such multiple patterns may be used by different AI components, computer vision detecting algorithms, and so forth, by the production function 135. As an example, permanent slide changes can be detected while concurrently detecting unstable connections of some participant clients 121, while other patterns detect a current main speaking participant 122. Using all such available pattern data, a classifier neural network can be trained, and/or a set of rules can be developed, for analysis of a time series of such pattern data. Such a classification may be at least partly, such as completely, supervised to result in determined desired state changes to be used in said production. For instance, different such predetermined classifiers can be produced, specifically arranged to automatically produce the output video stream 230 according to various and different production styles and desires. Training may be based on known production state change sequences as desired outputs and known pattern time series data as training data. In some embodiments, a Bayesian model can be used to produce such classifiers. In a concrete example, information can be a priori gleaned from an experienced producer, providing input such as “in a talkshow I never switch from speaker A to Speaker B directly but always first show an overview before I focus on the other speaker, unless that the other speaker is very dominant and speaking loud.” This production logic then be represented as a Bayesian model on the general form “if X is true | given the fact that Y is true | perform Z”. The actual detection (of whether someone is speaking loudly, etc.) could be performed using a classifier or threshold-based rules.

With large data sets (of pattern time series data), one can use deep learning methods to develop correct and appealing production formats for use in automated productions of video streams.

In some embodiments, the production function 135 may comprise information regarding what objects or human participant to show in the output video stream 230. For instance, in certain settings one or several participants 122 may not desire or be allowed to be shown to the consumer of the output video stream 230. Then, the production function 135 may produce the output video stream 230 to not show such one or several objects or human participants, based on digital image processing techniques for recognising the objects or humans in question and automatically crop primary video streams 210, 301 so as not to contain said objects or humans before being added as parts to the output video stream 230;

or to take production decisions so as not to include primary video streams 210, 301 currently showing said objects or humans in the output video stream 230.

In some embodiments, the production function 130 may be arranged to introduce externally provided information, such as in the form of a primary digital video stream 300 or other type of externally provided data, in response to detected patterns in one or several of said primary digital video streams 210, 301. For instance, the production function 130 may be arranged to automatically detect, via digital processing of imagery and/or sound included in said primary video streams 210, 301, a topic of discussion or a predetermined trigger event or pattern (such as a predetermined trigger phrase). In concrete examples, this may include automatically introducing in the output video stream 230 updated text or chart information from a remote source regarding a topic currently being debated by the participating users 122. In general, the detection of such trigger event or pattern may cause the production function 130 to modify its currently used production state in any way, as a function of the type or characteristics of the detected trigger event or pattern.

In summary, using a combination of the event detection based on individual primary video streams 210, 301; the deliberately introduced delay; the pattern detection based on several time-synchronised primary video streams 210, 301 and the detected events; and the production process based on the detected patterns, makes it possible to achieve automated production of the output digital video stream 230 according to a wide possible selection of tastes and styles. This result is valid across a wide range of possible neural network and/or rule-based analysis techniques used by the event detection function 132, pattern detection function 134 and production function 135.

As exemplified above, the production step S505 may comprise producing the output digital video stream 230 based on a set of predetermined and/or dynamically variable parameters regarding visibility of individual ones of said primary digital video streams 210, 301 in said output digital video stream 230; visual and/or audial video content arrangement; used visual or audio effects; and/or modes of output of the output digital video stream 230. Such parameters may be automatically determined by said production function 135 state machine and/or be set by an operator controlling the production (making it semi-automatic) and/or be predetermined based on certain a priori configuration desires (such as a shortest time between output video stream 230 layout changes or state changes of the above-exemplified types).

In practical examples, the state machine may support a set of predetermined standard layouts that may be applied to the output video stream 230, such as a full-screen presenter view (showing a current speaking participant 122 in full-screen); a slide view (showing a currently shared presentation slide in full-screen); “butterfly view”, showing both a currently speaking participant 122 together with a currently shared presentation slide, in a side-by-side view; a multi-speaker view, showing all or a selected subset of participants 122 side-by-side or in a matrix layout; and so forth. Various available production formats can be defined by a set of state machine state changing rules (as exemplified above) together with an available set of states (such as said set of standard layouts). For instance, one such production format may be “panel discussion”, another “presentation”, and so forth. By selecting a particular production format via a GUI or other interface to the central server 130, an operator of the system 100 may quickly select one of a set of predefined such production formats, and then allow the central server 130 to, completely automatically, produce the output video stream 230 according to the production format in question, based on available information as described above.

Furthermore, during the production a respective in-memory buffer may be created and maintained, as described above, for each meeting participant client 121 or external video source 300. These buffers can easily be removed, added, and changed on the fly. The central server 130 can then be arranged to receive information, during the production of the output video stream 230, regarding added/dropped-off participant clients 121 and participants 122 scheduled for delivering speeches; planned or unexpected pauses/resumes of presentations; desired changes to the currently used production format, and so forth. Such information may, for instance, be fed to the central server 130 via an operator GUI or interface, as described above.

As exemplified above, in some embodiments at least one of the primary digital video streams 210, 301 is provided to the digital video communication service 110, and the publishing step S506 may then comprise providing said output digital video stream 230 to that same communication service 110. For instance, the output video stream 230 may be provided to a participant client 121 of the video communication service 110, or be provided, via API 112 as an external video stream to the video communication service 110. This way, the output video stream 230 may be made available to several or all of the participants to the video communication event currently being achieved by the video communication service 110.

As also discussed above, in addition or alternatively the output video stream 230 may be provided to one or several external consumers 150.

In general, the production step S505 may be performed by the central server 130, providing said output digital video stream 230 to one or several concurrent consumers as a live video stream via the API 137.

FIG. 8 illustrates a method according to a first aspect of the present invention, for providing an output digital video stream, which method will be described in the following with reference to what has been described above. Hence, in the method illustrated in FIG. 8 all the mechanisms and principles described above regarding digital video stream collecting, event detection, synchronising, pattern detection, production and publishing may be applied.

Moreover, FIGS. 9 and 10 are respective simplified views of the system 100 in a configuration to perform the methods illustrated in FIG. 8.

In FIG. 9, there are three different central servers 130′, 130″, 130″ shown. These central servers 130′, 130″, 130′″ may be one single, integrated central server of the type discussed above; or be separate such central servers. They may or may not execute on the same physical or virtual hardware. At any rate, they are arranged to communicate one with the other.

In some embodiments, the central servers 130′ and 130″ may be arranged to execute on one and the same piece of physical hardware 402 (illustrated by dotted rectangle in FIG. 9), for instance in the form of a discrete hardware appliance such as a per se conventional computer device. In some embodiments, such discrete hardware appliance 402 is a computer device 402′ (see FIG. 10) arranged in, or in physical connection to, a meeting room, and specifically arranged to conduct digital video meetings in that room. In other embodiments, the discrete hardware appliance is a personal computer 402″, 402′″, such as a laptop computer, used by an individual human meeting participant 122, 122″, 122′″ to such digital video meeting, the participant 122, 122″, 122″ being present in the room in question or remotely.

Each of the central servers 130′, 130″, 130′″ comprises a respective collecting function 131′, 131″, 131′″, that may be as generally described above. The collecting function 131′ is arranged to collect a digital video stream 401 from a digital camera (such as the video camera 123 of the type generally described above). Such a digital camera may be an integrated part of said discrete hardware appliance 402 or a separate camera, connected to the hardware appliance 402 using a suitable wired or wireless digital communication channel. At any rate, the camera is preferably arranged locally in relation to the hardware appliance 402.

Each of the collecting functions 131″, 131′″ may collect a digital video signal corresponding to the digital video stream 401 directly from said digital camera or from collecting function 131′.

Each of the central servers 130′, 130″, 130″ may also comprise a respective production function 135′, 135″, 135′″. Each such production function 135′, 135″, 135′″ corresponds to the production function 135 described above, and what has been said above in relation to production function 135 applies equally to production functions 135′, 135″ and 135′″. There may also be more than three production functions, depending on the detailed configuration of the central servers 130′, 130″, 130′″. The various digital communications between the production functions 135′, 135″, 135′″ and other entities may take place via suitable APIs.

Moreover, each of the central servers 130′, 130″, 130′″ may comprise a respective publishing function 136′, 136″, 136′″. Each such publishing function 136′, 136″, 136′″ corresponds to the publishing function 136 described above, and what has been said above in relation to publishing function 136 applies equally to publishing functions 136′, 136″ and 136′″. The publishing functions 136′, 136″, 136″ may be distinct or co-arranged in one single logical function with several functions, and there may also be more than three publishing functions, depending on the detailed configuration of the central servers 130′, 130″, 130′″. The publishing functions 136′, 136″, 136′″ may in some cases be different functional aspects of one and the same publication function 136, as the case may be.

Whereas the publishing functions 136″ and 136″ are optional, and may be arranged to output a different (possibly more elaborate, associated with a respective time delay) video stream than a video stream output by publishing function 136′, the publishing function 136′ is arranged to output the output digital video stream according to the present invention. Generally speaking, production functions 135″ and 135″ are arranged to process the incoming video stream so as to produce production control parameters to be used by the production function 135′ so as to produce said output video stream according to the present invention.

FIG. 9 also shows three external consumers 150′, 150″, 150″, each corresponding to external consumer 150 described above. It is realised that there may be less than three; or more than three such external consumers 150′, 150″, 150′″. For instance, two or more of the publishing functions 136′, 136″, 136′″ may output to one and the same external consumer 150′, 150″, 150′″, and one of the publishing functions 136′, 136″, 136′″ may output to more than one of said external consumers 150′, 150″, 150″″. It is also noted that at least the publishing function 136′ may publish the produced video stream back to the collecting function 131′. Furthermore, each of the publishing functions 136′, 136″, 136′″ may be arranged to publish the respective produced video stream in question to a participant client 121 of the general type discussed above.

It is realised that the consumer 150′ may be a participant client 121 that also comprises the central server 130′, for instance by a laptop computer 402″, 402′″ being arranged with the functionality of central server 130′ (and possibly also central server 130″) and providing a corresponding human user 122″, 122′″ with the enhanced, real-time output video stream on a screen of said laptop computer 402″, 402′″ as a part of the video communication service in which the human user 122″, 122″ participates.

Moreover, FIG. 9 shows three external information sources 300′, 300″, 300′″, each corresponding to external information source 300 described above and providing information to a respective one of said collecting functions 131′, 131″, 131′″. It is realised that there may be less than three; or more than three such external information sources 300′, 300″, 300′″. For instance, one such external information source 300′, 300″, 300′″ may feed into more than one collecting functions 131′, 131″, 131′″; and each collecting function 131′, 131″, 131′″ may be fed from more than one external information source 300′, 300″, 300′″.

FIG. 9 does not, for reasons of simplicity, show the video communication service 110, but it is realised that a video communication service of the above-discussed general type may be used with the central servers 130′, 130″, 130′″, such as providing a shared video communication service to a participating client 121 using the central servers 130′, 130″, 130′″ in the way discussed above. In some embodiments, central server 130″ constitutes, comprises or is comprised in the video communication service 110.

FIG. 10 illustrates three different exemplifying hardware appliances, namely a meeting room hardware appliance 402′ comprising a digital camera 401′ in turn arranged to capturing imagery showing one or more human meeting participants 122″, 122′″, 122″″ in a meeting locality, room or venue; and two laptop computers 402″, 402′″, each comprising a respective digital web camera 401″, 401′″ arranged to capture imagery showing a respective on of said human meeting participant 122″, 122′″ using the laptop computer 402″, 402′″ in question. It is understood that FIG. 10 shows one of many different configurations, with the purpose of illustrating the principles of the present invention, and that other types of configurations are possible. For instance, only some of the participants 122″, 122′″, 122′″ may be visible to the camera 401′; additional participating users (that are not shown in FIG. 10) may participate in the video communication service remotely; external information sources may be used; and so forth as exemplified herein. As used herein, the term “remotely” means not “locally”. Two entities arranged “remotely” one in relation to the other are preferably arranged to communicate via the open internet (WAN).

An exemplifying one of the participant users 122″″ is not visible to cameras 410″, 401″″, but only from camera 401′.

Each of the hardware devices 402′, 402″, 402′″ may correspond to the device 402 shown in greater detail in FIG. 9, and each of the hardware devices 402′, 402″, 402″″ may be arranged to communicate, via the internet 10 or another digital communication network, with video communication service 110. It is noted that the video communication service 110 may then provide the shared video communication service using devices 402′, 402″, 402′″ as participant users 121 of the general type described above. In some embodiments, the video communication service 110, such as the central server 130″ is remote in relation to the central servers 130′, 130″.

Turning back to FIG. 8, in a first step S800 the method starts.

In a subsequent collecting step S801, one or several real-time first primary digital video streams 210, 301 is or are continuously collected. In the case illustrated in FIGS. 9 and 10, the video stream 210, 301 is stream 401, continuously collected from any one of the cameras 401′, 401″, 401′″, by collecting function 131′ (and/or 131″, 131′″, in the case of collection of the external information source 300).

That the first primary digital video stream is a “real-time” stream means that it is provided from a capturing camera to the collecting function 131 in question without any delay, and without any time-consuming image processing before reaching the collecting function 131. For instance, any data processing and/or communication between the capturing of the image frames of the camera sensor until the corresponding digital video stream is stored in the collecting function 131 may be less than 0.1 s, such as less than 0.05 s.

As mentioned above, the first primary digital video stream 210, 301 may be continuously captured by a camera 410′, 401″, 401′″ arranged locally in relation to a participating client 121 consuming the output video stream, such as the device 402, 402′, 402″, 402′″ itself.

Moreover, the first primary digital video stream 210, 301 may be continuously captured by a camera 401′, 401″, 401′″ arranged to capture imagery showing a participating user 122″, 122″″ of the device 402″, 402′″ (participating client 121) in question.

In these and other cases, the first primary digital video stream 210, 301 may be continuously captured by a camera 401′, 401″, 401′″ arranged physically locally (“locally” as defined above) in relation to a computer device 402′, 402″, 402′″ performing an application of the first production control parameter (see below).

In a subsequent production step S804, a first digital image analysis is performed with respect to at least one of the collected first primary digital video stream or streams 210, 301. This digital image analysis results in that at least one first event 211 or pattern 212 of the general type discussed above is detected in the first primary digital video stream 210, 301 in question. In particular, this first digital image analysis results in a first production control parameter being established, in a subsequent step S805, based on the detection of said first event 211 or pattern 212.

The digital image analysis itself may take place in any suitable manner, such as is well-known per se in the art.

The detection of said event 211 or pattern 212 may have different purposes. Generally, it may be desired to affect the video or videos being shown to participant users 122 of a video communication service 110. Such affecting may comprise dynamically selecting a virtual cropping and/or panning and/or zooming and/or tilting of a captured primary digital video stream so as to highlight or follow participant users 122 of a physical object shown in the primary digital video stream in question and/or to highlight a current speaker or a physical object shown in the primary digital video stream and currently being discussed. Such affecting may furthermore comprise adding additional information, such as metadata or externally provided information, to the primary digital video stream based on, for instance, what is currently being discussed by participant users 122 shown in said primary video stream, such as heard in an audio uptake from the meeting venue and discerned using a digital sound processing step including natural language interpretation.

Hence, the first production control parameter may comprise a visual location of, or visual tracking information with respect to, a stationary or moving object or participating user 122 in the first primary digital video stream 210, 301, the location or tracking information being automatically detected using digital image processing. Hence in this case the detected event 211 or pattern 212 is the location or movement of such object or user in the primary digital video stream 210, 301. Such visual tracking information may comprise information about a virtual cropping, panning or zooming to be applied to the primary digital video stream 210, 301 so as to achieve imagery showing the object or participating user 122 as a subpart of the primary digital video stream 210, 301 in question. Hence, the first production control parameter will typically not comprise information about a physical motion or the camera capturing the primary digital video stream 210 301 in question, but rather instructions regarding how to modify the first primary digital video stream 210, 301 so as to show the object or participating user 122. This is generally true in the sense that the production control parameters discussed herein preferably do not contain any instructions regarding a physical movement of any hardware equipment belonging to the system 100, but rather only on digital post-capturing processing of imagery captured by one or several cameras 401′, 401″, 401′″.

The first production control parameter may furthermore comprise a discrete production command, automatically generated based on the detection of the predetermined event 211 or pattern 212, and/or automatically generated based on a predetermined or variable production schedule. For instance, an event 211 may be the automatic detection of a particular predetermined object of interest in the primary digital video stream 210, 301, and the discrete production command may then be to show in the output digital video stream a brief instruction video regarding that predetermined object. That the production command is “discrete” means that the production command is to be applied only once, at a discrete point in time and not across a stretch of time. For instance, the production command may be to launch such an instruction video.

The first production control parameter may furthermore comprise a virtual cropping, panning, tilting and/or zooming instruction, such as parameter data describing such cropping/panning/tilting/zooming in order to follow or highlight a participating user 122 or object of the type discussed above. The virtual cropping, panning, tilting and/or zooming instruction may be static or dynamically change along a timeline of the primary digital video stream, such as between individual frames thereof.

The first production control parameter may furthermore comprise camera stabilising information, automatically generated based on the detection of a movement of the camera 401′, 401″, 401′″ providing the primary digital video stream in question. Hence, in this case the digital video analysis aims at dynamically detecting, in a way which may be conventional as such, an event 211 or pattern 212 in the form of a shaking or other movement of the camera 401′, 401″, 401′″ in question, such as due to the camera 401′, 401″, 401′″ being operated by hand by one of the participating users 122″, 122′″, 122″″, and the first production control parameter may be a panning/rotation/tilting/zooming instruction with respect to the primary digital video stream 210, 301 aiming for, when applied thereto, at least partly counteract the detected movement and/or stabilise the primary digital video stream 210, 301 over time. Said movement of the camera 401′, 401″, 401′″ in question may be detected based entirely on image processing of the primary digital video stream, using per se conventional image processing techniques, for instance pixel correlation techniques to detect image translations across frames.

In all these examples, the first digital image analysis will take a certain time to perform due to the calculations involved. As a result, the first production control parameter will be established with a first time delay in relation to a time of occurrence of said first event 211 or pattern 212 in the first primary digital video stream 210, 301. This first time delay may be sufficiently large so as to produce a noticeable sound delay in case the primary digital video stream, having said first time delay, is not time-synchronised with a corresponding captured digital sound stream; and/or the first time delay may be sufficiently small so as not to cause interaction difficulties for participating users 122″, 122′″, 122″″ interacting with each other using said digital video communication service 110. Concretely, the first time delay may be more than 0.1 s. In this and in other embodiments, the first time delay may be less than 1 s, such as less than 0.5 s, such as less than 0.3 s.

In a subsequent production step S806, said first production control parameter is applied to the real-time first primary digital video stream 210, 301, as a part of the production of the digital output video stream. The application of the first production control parameter results in that the first primary digital video stream 210, 301 is modified based on the first production control parameter, so as to produce a first produced digital video stream. This modification, however, takes place without the primary digital video stream itself being delayed by said first time delay.

Hence, it is the non-delayed first primary digital video stream 210, 301 that is affected by the application of the first production control parameter, even though the first production control parameter was determined only after said first time delay (due to it taking a certain time to establish the first production control parameter). In other words, the first production control parameter will be applied to the first primary digital video stream 210, 301 at a time along a timeline of the first primary digital video stream 210, 301 which is later, by at least the first time delay, than a point along said timeline when the event 211 or pattern 212 was detected. So, if the event 211 or pattern 212 for instance is the detected movement of an object in a frame x of the first primary digital video stream 210, 301, the first production control parameter may be to translate a virtual cropping of the first primary digital video stream 210, 301 so as to follow the object to its new position. However, the first production control parameter will be established only at the first time delay, such as y frames (for instance, y=10 frames) frames of the first primary digital video stream 210, 301. Hence, when the first production control parameter is applied so as to effect said movement of the cropping, this movement of the cropping of the first primary digital video signal 210, 301 will relate to frame x+1 y of the first primary digital video signal 210, 301.

In some embodiments, the first digital image analysis is performed by a computer device 402 that is also arranged to produce and publish the output digital video stream 230. In particular, it may be the production function 135″ of the central server 130″, that is part of the same physical computer device 402 that also comprises the central server 130′, which performs the first digital image analysis and establishes the first production control parameter. It may then be the central server 130′ (via production function 135′) that applies the first production control parameter.

This minimises the first time delay, since no communication with external or peripheral computer devices is necessary for the establishment and application of the first production control parameter.

This also makes it possible for any camera-enabled hardware device 402′ that is already installed in a meeting room or venue, and/or any laptop 402″, 402′″ or similar used by any meeting participant 122, to be used to produce an enhanced shared digital video conference service that in turn can be accessed and used by other meeting participants 122 as a part of the same interactive digital video communication session in the context of which the first primary digital video stream 210, 301 originates.

In other examples, several such hardware devices 402′, 402″, 402″″ can each be devices 402 of the type illustrated in FIG. 9, each concurrently producing and publishing a respective enhanced output digital video stream 230 for other participant users 121 to consume, or for a common central video communication service 110 to use in combination, for an even more elaborate production of a common digital video communication service experience. Since such output digital video stream 230 will be provided in real-time, without said first time delay, the production of the central video communication service 110 can result in a relatively low-latency video communication even if the central video communication 110 deliberately adds a latency as described above, for production purposes.

For instance, in a classroom, a fixed computer device 402′ having a wide-angle web camera 401′ may be a computer device 402 of the type illustrated in FIG. 9, capturing imagery showing all, or all least several of, students in the classroom. At the same time, one or several of the students may run their own computer devices 402 in the form of webcam-enabled laptops 402″, 402″, capturing imagery only showing that student in question. All devices 402′, 402″, 402′″ may then produce and publish respective enhanced, real-time output digital video streams 230 that can be viewed on the respective device 402′, 402″, 402′″ in question, thus forming a first group of participants 121 associated with very low latency, and/or also be used by a central video communication service 110 to produce, at a slight delay, a more elaborate common video communication experience that can be consumed by external participants or viewers, forming a second group of participants 121 associated with a larger latency.

It is noted that all involved collecting, analysing and production in such cases can be configured to take place in a completely automatic manner, based on parameter input to the system 100 and resulting in automatically and dynamically applied production steps.

The first digital image analysis and the publishing of the output digital video stream 230 may be performed on the same physical computer device 402 but using computer software at least partly operating in separate processes or threads, at least with respect to the first digital image analysis and the application of the first production control parameter to produce the output digital video stream 230.

In order to provide a high-quality, low-latency output digital video stream 230, in some embodiments processor-throttling with respect to the first digital image analysis can be performed, as a function of current processor load of the computer device 402 performing the first digital image analysis. This is particularly true in case the central servers 130′, 130″ execute on one and the same central processor unit. Such processor-throttling may take place in a way so that the provision and publication of the output digital video stream 230 (central server 130′) has processor priority over the first digital image analysis (central server 130″). In other words, under limited CPU conditions the production function 135′ and the publishing function 136′ will be given CPU priority as compared to the production function 135″. For instance, the processor-throttling of the first digital image analysis may be performed by limiting the first digital image analysis to only a subpart of all video frames of the first primary digital video stream 210, 301, such as the first digital image analysis only being performed with respect to every other or every third frame, or the first digital image analysis only being performed with respect to one frame each given time unit, such as only one frame per 0.1 second or less frequently. In many cases, this may provide sufficiently accurate event 211 or pattern 212 detection while still maintaining high video quality in the output digital video stream 230. Throttling may be used at all times, or may be switched on or off as needed. In the latter case, throttling may be switched on as a result of a detection that available CPU capacity is too small so as to be able to be able to provide and publish the output digital video stream 230 at a desired minimum video quality.

In a subsequent publication step S807, the output digital video stream 230 is continuously provided (published), by publishing function 136′, to at least one participating client 121. It is noted that the participating client 121 may be the same computer device 402 performing the production of the output digital video stream 230, so as to provide a user 122 of the computer device 402 with an enhance, low-latency video stream for viewing. The participating client 121 may also be another computer device 402′, 402″, 402′″, and it can also be a video communication service 110 using the produced and published output digital video stream 230 to produce a second-tier output digital video stream as discussed above.

The output digital video stream 230 is provided and published in the form of, or based on, said first produced digital video stream, in turn being produced by production function 135′. As mentioned above, the output digital video stream 230 may be produced and made available in several layers or stages. For instance, the output digital video stream 230 may be produced based on both said first primary digital video stream 210, 301 and said first produced digital video stream, by the same or different hardware device 402 producing the first produced digital video stream in question.

In a subsequent step S808, the method ends. However, iteration will typically occur, as is illustrated in FIG. 8.

The production performed by production step 135′ should be as fast as possible, only applying the production control parameter established by production step 135″ to the first primary digital video stream 210, 301 and outputting the resulting first produced digital video stream continuously and in real-time. As has been explained above, any information about how to crop or otherwise adjust the primary digital video stream 210, 301, including any add-ons (for instance in the form of externally provided video material or metadata) is received from production function 135″, resulting in said time discrepancy regarding the application of the first production control parameter and the contents of the first primary video stream 210, 301 based on which the value of the first production control parameter is established in the first place.

Then, the first produced digital video stream may be exposed as a real-time, enhanced primary video stream input to any collecting function 131, 131′, 131″, 131′″.

It is realised that the application of the first production control parameter, such as performing a crop or zoom of the video frames in the digital domain, can be very fast, resulting in minimal time delay. For instance, the application of the first production control parameter may result in a delay of the first produced digital video stream (in relation to the first primary digital video stream) of at the most 0.2 s.

Then, the collecting function 131′ may further comprise continuously collecting or capturing, in addition to or as a part of the first primary digital video stream 210, 301, a first digital audio stream, the first digital audio stream in turn being associated with the first primary digital video stream 210, 301. Once collected/captured, the first digital audio stream can be time-synchronised with the first produced video stream 210, 301, in practise by delaying the first primary digital audio stream slightly, and the time-synchronised first digital audio stream may then be provided to said at least one participating client 121 or collecting function 131 together with or as a part of the first produced digital video stream and/or the output digital video stream 230.

This way, both video and corresponding audio may be input to the collecting function 131′, and an enhanced bundle of synchronised video and corresponding audio may be output by the publishing function 136′ after enhancement but at minimum time delay. This way, the central server 130′, as aided by central server 130″, can be viewed as a “virtual video cable”, operating at only minimal time delay but being capable of outputting at a distal end an enhanced version of the input video/audio information input at a proximal end.

In the production function 135″, the video analysis producing said enhancement takes place, and results in the establishment of the first production control parameter as discussed above. This may involve to detect a particular person in the image; to select a cropping or virtual zooming, in order to follow and/or focus upon a particular moving person in the image; to identify a counteracting virtual camera movement so as to stabilise the camera to achieve a soft panning/movement of the camera; and so forth. This analysis results in a number of decisions/instructions to the production function 135′, resulting in a small time delay before that decision/instructions can be applied. It has turned out that this small time delay does generally not negatively impact the experience of a consuming user 122 of the output digital video stream 230, even in case of camera-following. Even if a human camera operator performs camera-following with respect to a moving person or object, the operator has a certain minimum reaction time. Also, the production function 135″ may be configured to detect an event 211 or pattern 212 ignoring small movements of the person or object being followed, and only perform a virtual camera panning or movement in reaction to larger movements, and so on. A multi-threaded software implementation on the same physical computer hardware, such as described above, makes it possible to achieve this using a single hardware appliance 402 in a way wherein the production complexity does not affect for instance image or sound quality of the first produced digital video stream, across a wide array of possible hardware platforms.

It is specifically noted that the first production control parameter is only arranged to control a digital transformation of the first primary digital video stream 210, 301. It may be possible for the first production function 135′ to also provide instructions to the camera in question to perform a physical panning, zooming or similar, but this would be outside of the scope for the present invention.

As illustrated in FIG. 8, the method may further comprise the step S802 of performing a second digital image analysis of the first primary digital video stream 210, 301. In some embodiments, the method comprises the step S802 of performing a second digital audio analysis of a digital audio stream continuously captured and associated with the first primary digital video stream 210, 301.

The second image/audio analysis is performed so as to identify at least one second event 211 or pattern 212 in the first primary digital video stream 210, 301 and/or in said digital audio stream, and in order to, in a subsequent step S803, establish a second production control parameter. The second production control parameter may be generally similar to the first production control parameter described above.

In a way that is similar to the first image analysis, the second digital image/audio analysis takes a certain time to perform, causing the second production control parameter to be established after a second time delay in relation to a time of occurrence of said second event 211 or pattern 212 in the first primary digital video stream 210, 301. However, the second time delay is longer than the first time delay.

Then, said second production control parameter is applied to the real-time first primary digital video stream 210, 301, resulting in the first primary digital video stream 210, 301 being modified based on said second production control parameter without being delayed by said second time delay, so as to produce said first produced digital video stream.

In practise, the second production control parameter may be directly applied, by the production function 135′, to the first primary digital video stream 210, 301 in a way that corresponds to the application of the first production control parameter. In other embodiments, the second production control parameter, being established at a larger latency than the first production control parameter, may be applied only indirectly to the first primary digital video stream 210, 301, such as by affecting a value of the first production control parameter before the first production control parameter is applied to the first primary digital video stream 210, 301. For instance, the second production control parameter may be related to broader production aspects, such as selection of a currently shown camera angle or presentation slides, whereas the first production control parameter may be related to more detailed production aspects, such as an exact currently applied virtual panning or cropping.

The second digital image analysis may be performed by a computer device which is remote in relation to a computer device performing the application of the first production control parameter, and/or remote in relation to a computer device performing the application of the second production control parameter. In the example shown in FIG. 9, the computer device 402 applies the first production control parameter, and possibly also the second production control parameter, and that computer device 402 is remote in relation to a computer device on which the central server 130′″ executes.

In some embodiments, the second production control parameter constitutes an input to the first digital image analysis. For instance, the second production control parameter may comprise information identifying a particular person or object being viewed in the first primary digital video stream 210, 301, and this identifying information may be used as an input to the first digital image analysis performing a tracking (by virtual panning and/or zooming) of the identified person or object as it moves through the image frames constituting the first primary digital video stream 210, 301.

Hence, the second production control parameter may comprise an instruction regarding whether or not to show, in said first produced digital video stream, a certain participating user being shown in the unaffected captured imagery, the participating user in question being automatically identified based on digital image processing.

In this and other embodiments, the second production control parameter may comprise a second primary video stream 210, 301, for instance a second primary video stream 210, 301 to be incorporated into the first produced digital video stream.

That the second time delay is larger than the first time delay may be the case due to the second image and/or audio processing taking more time than the first image processing, and/or due to the communication between, on the one hand, the central servers 130′, 130″ and, on the other hand, the central server 130″, taking time.

In general, the second digital image processing, resulting in the establishment of the second processing control parameter, may constitute a load relief from the first digital image processing, such as in case the hardware device 402 hits it capacity roof. To offload some of the first image analysis to the central server 130″ may then be a reasonable trade-off in terms of accepting the larger time delay for the application of the second production control parameter but at the same time gaining the more complete image analysis.

However, in general the central server 130″ may be a cloud resource, or other external computing resource with vastly more processing power and/or quick access to larger databases of external data than what is the case for the central server 130″ (that may be locally arranged as described above). Therefore, it is preferred that the second image and/or audio analysis comprises tasks that are more advanced and therefore more processing demanding than the first image analysis.

For instance, the second image processing may comprise advanced facial recognition, based on a database of potential persons to detect and their facial features. In contrast, the first image processing may comprise an algorithm locating and tracking an already identified face of such identified person in the first primary digital video stream 210, 301.

The second image or audio processing may also comprise association of automatically interpreted information in the analysed imagery and/or audio (what is viewed, or what is talked about) to external data. For instance, in case the automatic audio processing comprises a natural language detection, parsing and interpretation component, it may come to the conclusion that a speaker heard in said audio is talking about a particular flower species. Then, the second production control parameter may comprise information to incorporate a particular image showing a flower of said flower species into the first produced digital video stream. Correspondingly, the second image processing may reveal that the logo of a particular rock band is shown in the first primary digital video stream, and the second production control parameter may comprise instructions to show an image of the rock band in question in the first produced digital video stream.

It is noted that the establishment of the first and second production control parameters may be performed based on an available space of possible such production control parameters and associated values, such space possibly being defined by configuration parameters definable by a user of the video communication service 110. For instance, in a video communication service 110 used to give a lecture about geography, the production function 135″ may be instructed, via such configuration parameters, to monitor any mentioned or mentioned (in text on a shown whiteboard, for example) countries, and to automatically produce a second production control parameter specifying to show the corresponding flag in a particular predetermined sub stream of the first produced digital video stream.

In some embodiments, only the digital audio stream, and not the first primary digital video stream 210, 301, is sent to the production function 135′″ of the central server 130″. This will cut back considerably on the amount of data that needs to be communicated to the central server 130′″ (that may be remotely arranged, as described above).

In a concrete example, the second production control parameter is continuously established, based on the second digital image processing performing facial recognition, so as to instruct the production function 135′ to select and virtually pan/crop/zoom one or several primary digital video streams so as to show a teacher in the output digital video stream, but not to show any of the students. This way, an output digital video stream that does not risk the integrity of showing faces of the students is performed. As explained above, the virtual pan/crop/zoom operations may in practise be performed by the first image processing and via the first production control parameter, using input in the form of the second production control parameter.

In this case, an associated digital audio stream associated with the first produced digital video stream may also be affected by the first and/or the second production control parameter. This may include selecting among a set of several available primary digital audio streams, such as captured by different microphones of participant users to the communication service 110, but it may also involve digitally suppressing or enhancing certain sounds. In the example with a teacher and students, questions posed by students may be muffled, while answers from the teacher may be unaffected, in the first produced digital video stream.

The present invention also relates to a computer program product comprising instructions which, when the program is executed by a computer, cause the computer to carry out the method for providing an output digital video stream 230 according to any preceding claim.

The computer program product may be implemented by a non-transitory computer-readable medium encoding instructions that cause one or more hardware processors located in at least one of computer hardware devices in the system to perform the method steps described herein.

The invention also relates to said system 100, in turn comprising said one or several collecting functions 131, 131′, 131″, 131′″, in turn being arranged to continuously collect the real-time first primary digital video stream 210, 301; said one or several production functions 135, 135′, 135″, 135′″, in turn being arranged to perform said first digital image analysis to establish said first production control parameter as described herein; and said one or several publication functions 136, 136′, 136″, 136′″, in turn being arranged to continuously provide said output digital video stream 230 as described herein.

The system 100 may further comprise several cameras, each being arranged to capture a respective non-delayed primary digital video stream 210, 301. Then, the production function 135′ may be arranged to produce said non-delayed first produced digital video stream based on each of said captured primary digital video streams 210, 301.

Above, preferred embodiments have been described. However, it is apparent to the skilled person that many modifications can be made to the disclosed embodiments without departing from the basic idea of the invention.

For instance, many additional functions can be provided as a part of the system 100 described herein, and that are not described herein. In general, the presently described solutions provide a framework on top of which detailed functionality and features can be built, to cater for a wide variety of different concrete application wherein streams of video data is used for communication.

One example is that the output digital video stream may form an input primary digital video stream for another automatic digital video production method or system of the present or a different type.

The first and second event/pattern have been specifically exemplified above in connection to FIGS. 8-10, but it is realised that many other types of events and patterns are thinkable. Possible types of events and patterns have been discussed throughout the present specification, and the skilled person realises that these examples and discussions are for explanatory purposes and is not intended to constitute a limiting list.

In general, all which has been said in relation to the present method is applicable to the present system and computer program product, and vice versa as applicable.

Hence, the invention is not limited to the described embodiments, but can be varied within the scope of the enclosed claims.

1. A method for providing an output digital video stream, comprising:
continuously collecting a real-time first primary digital video stream;
performing a first digital image analysis of the first primary digital video stream to identify at least one first event or pattern in the first primary digital video stream, the first digital image analysis resulting in a first production control parameter being established based on the detection of the first event or pattern, the first digital image analysis taking a certain time to perform causing the first production control parameter to be established after a first time delay in relation to a time of occurrence of the first event or pattern in the first primary digital video stream;
performing a second digital image analysis of the first primary digital video stream, and/or a second digital audio analysis of a digital audio stream continuously captured and associated with the first primary digital video stream, to identify at least one second event or pattern in the first primary digital video stream and/or the digital audio stream, the second digital image or audio analysis taking a certain time to perform causing a second production control parameter to be established after a second time delay in relation to a time of occurrence of the second event or pattern in the first primary digital video stream, the second time delay being longer than the first time delay;
applying the first and second production control parameters to the real-time first primary digital video stream, the application of the second production control parameter resulting in the first primary digital video stream being modified based on the second production control parameter without being delayed by the second time delay, to produce a first produced digital video stream, wherein the second production control parameter is applied to the first primary digital video stream at a time in the first primary digital video stream which is later, by at least the second time delay, than the time of occurrence of the second event or pattern in the first primary digital video stream;
continuously providing the output digital video stream to at least one participating client, the output digital video stream being provided in the form of, or based on, the first produced digital video stream, wherein
the first primary digital video stream is continuously captured by a camera arranged locally in relation to the participating client and locally in relation to a computer device performing the first digital image analysis and the application of the first production control parameter, and wherein
the second digital image analysis is performed by a computer device which is remote in relation to the computer device performing the application of the first production control parameter.

2. The method of claim 1, further comprising:
producing the output digital video stream based on both the first primary digital video stream and the first produced digital video stream.

3. The method of claim 2, wherein the collecting further comprises continuously capturing a first digital audio stream associated with the first primary digital video stream, the method further comprising:
time-synchronising the first digital audio stream with the first produced video stream; and
providing the time-synchronised first digital audio stream to the at least one participating client together with or as a part of the output digital video stream.

4. The method of claim 1, wherein the first primary digital video stream is continuously captured by a camera so as to show a participating user of the participating client in the first primary digital video stream.

5. The method of claim 1, wherein the first production control parameter comprises one or several of:
a) a location of, or tracking information with respect to, a stationary or moving object or person in the first primary digital video stream, the location or tracking information being automatically detected using digital image processing;
b) a discrete production command, automatically generated based on the detection of a predetermined event or pattern, and/or automatically generated based on a predetermined or variable production schedule;
c) a virtual panning and/or zooming instruction; and
d) camera stabilising information, automatically generated based on a camera movement detection.

6. The method of claim 1, wherein the first digital image analysis is performed by a computer device that is also configured to provide the output digital video stream to the at least one participant client.

7. The method of claim 6, wherein the first digital image analysis and the providing of the output digital video stream are performed in separate processes or threads.

8. The method of claim 6, further comprising:
processor-throttling the first digital image analysis as a function of current processor load of the computer device performing the first digital image analysis, so that the provision of the output digital video stream has processor priority over the first digital image analysis.

9. The method of claim 8, wherein the processor-throttling of the first digital image analysis is performed by limiting the first digital image analysis to only a subpart of all video frames of the first primary digital video stream.

10. The method of claim 1, wherein the second production control parameter constitutes an input to the first digital image analysis.

11. The method of claim 10, wherein the second production control parameter comprises one or several of:
a) a second primary video stream; and
b) an instruction regarding whether or not to show, in the first produced digital video stream, a certain participating user, the participating user in question being automatically identified based on digital image processing.

12. A computer program product comprising a computer program stored on a non-transitory computer-readable medium, the computer program comprising instructions which, when the computer program is executed by a computer, cause the computer to carry out the method claim 1.

13. A system for providing an output digital video stream, comprising:
a collecting function, configured to continuously collect a real-time first primary digital video stream;
a first production function, configured to perform a first digital image analysis of the first primary digital video stream to identify at least one first event or pattern in the first primary digital video stream, the first digital image analysis resulting in a first production control parameter being established based on the detection of the first event or pattern, the first digital image analysis taking a certain time to perform so that the first production control parameter is established at a first time delay in relation to a time of occurrence of the first event or pattern in the first primary digital video stream,
a second production function, configured to perform a second digital image analysis of the first primary digital video stream, and/or a second digital audio analysis of a digital audio stream continuously captured and associated with the first primary digital video stream, to identify at least one second event or pattern in the first primary digital video stream and/or the digital audio stream, the second digital image or audio analysis taking a certain time to perform causing a second production control parameter to be established after a second time delay in relation to a time of occurrence of the second event or pattern in the first primary digital video stream, the second time delay being longer than the first time delay;
the system being configured to apply the first and second production control parameters to the real-time first primary digital video stream, the application of the second production control parameter resulting in the first primary digital video stream being modified based on the second production control parameter without being delayed by the second time delay, so as to produce a first produced digital video stream; wherein the second production control parameter is applied to the first primary digital video stream at a time in the first primary digital video stream which is later, by at least the second time delay, than the time of occurrence of the second event or pattern in the first primary digital video stream, and
a publication function, configured to continuously provide the output digital video stream to at least one participating client, the output digital video stream being provided in the form of, or based on, the first produced digital video stream, wherein
the first primary digital video stream is continuously captured by a camera arranged locally in relation to the participating client and locally in relation to a computer device performing the first digital image analysis and the application of the first production control parameter, and wherein
the second digital image analysis is performed by a computer device which is remote in relation to the computer device performing the application of the first production control parameter.

14. The system of claim 13, wherein:
the system further comprises several cameras, each camera being configured to capture a respective non-delayed primary digital video stream; and
the first production function is configured to produce the non-delayed first produced digital video stream based on each of the captured primary digital video streams.
